(19) United States
(12) Patent Application Publication
(10) Pub. No.: US 2025/0215848 A1
(43) Pub. Date: Jul. 3, 2025

(54) GLOBAL PERPETUAL ENERGY OCEAN BLANKET

(71) Applicant: The Texas A&M University System, College Station, TX (US)

(72) Inventors: Terry Wayne Henry, Greenville, TX (US); Chaitanya Chowdary Kesanapalli, Galveston, TX (US); HeonYong Kang, Houston, TX (US)

(21) Appl. No.: 18/986,695

(22) Filed: Dec. 18, 2024

Related U.S. Application Data
(60) Provisional application No. 63/615,259, filed on Dec. 27, 2023.

(51) Int. Cl. F03B 13/20; F03B 15/00

(52) U.S. Cl. CPC F03B 13/20; F03B 15/00

(57) ABSTRACT

This disclosure provides systems, methods, and devices for extracting energy from ocean waves. In a first aspect, an energy generation system includes a plurality of pods and a truss structure coupled to a pod array. The truss structure includes one or more trusses, where at least one truss of the one or more trusses includes a generator configured to generate energy. The pods include buoyant material and are configured to float and suspend the truss structure in water and move with incoming waves, and the pods are flexibly coupled to one another and configured to move relative to one another from incoming waves. Movement of the pods causes movement of the at least one truss of the one or more trusses and the generator thereof and generation of electricity. Other aspects and features are also claimed and described.

### CROSS-REFERENCE TO RELATED APPLICATIONS

The present application claims the benefit of priority from U.S. Provisional Application No. 63/615,259 filed Dec. 27, 2023 and entitled “GLOBAL PERPETUAL ENERGY BLANKET,” the disclosure of which is incorporated herein by reference in its entirety.

### TECHNICAL FIELD

Aspects of the present disclosure generally relate to a system of devices that capture energy resident in ocean waves to power a generator and generate electrical power.

### BACKGROUND OF THE INVENTION

A wave energy converter (WEC) captures energy from ocean surface waves, usually for electricity generation. However, prior attempts at wave power conversion have not been widely implemented for various reasons. Wave power is available at low speeds with high forces, and the motion of wave and resulting forces are not in a single direction. Waves travel in multiple directions and often move in irregular patterns, which means the wave oscillation has irregular frequencies and changes in direction as well as magnitude. Conventional WECs often are designed to capture energy in a single direction of travel or in a limited amount of wave paths with a single oscillation frequency. Previous wave systems that attempt to capture waves in multiple directions are not viable as their efficiency is too low for practical use.

Most WECs have been designed to be effective only with strong boundary conditions and for extracting energy from fixed unidirectional waves. The strong boundary conditions refer to the WEC being tied down or anchored in a specific place and such may be accomplished using taut mooring lines, tendons, anchors, or other fixed boundary conditions. The strong boundary condition requirements of conventional WECs make the wave energy conversion too expensive to commercialize, and the requirement of the single fixed direction of the waves means those WECs will not be effective for most ocean waves, which change direction along with frequency and magnitude.

Moreover, although the ocean wave energy for a single wave is spread over tens to hundreds of meters, most WECs are designed in various scales up to tens of meters and their array configurations are designed using a simple superposition approach. Those WEC designs on such a small scale are inherently unable to capture the wave energy spread on a much larger scale, and thus the performance has been ineffective even after the simple array-type superposition.

### BRIEF SUMMARY OF THE INVENTION

The presently disclosed ocean wave energy conversion system also referred to as an ocean blanket system or a global perpetual energy ocean blanket includes a system of wave energy converters configured to convert ocean wave energy into electrical power through elastic deformation that resonates with varying multidirectional irregular waves. Specifically, ocean waves vary in direction, frequency, and height over time, and are known as “varying multidirectional irregular waves.” When the ocean waves interact with and pass through the ocean wave energy conversion system, the varying multidirectional irregular waves excite the ocean wave energy conversion system and produce resonance responses for a set of elastic deformation modes of the ocean wave energy conversion system. The elastic deformation causes the generators of the system to move and generate power. The resonance adapting with the variation of the multidirectional irregular waves improves energy capture from the ocean waves in the area covered by the system to the mechanical power, which subsequently produces the maximum or significantly increased electrical power out of that maximum mechanical power. The ocean wave energy conversion system includes an array of floating pods, a plane truss structure system, and generators. The pods may be connected at the bottom of the plane truss system, and generators may be equipped along or replaced with the top or other bars of the plane truss system. The plane truss system is flexible, and the movement of the plane truss system causes the generator to generate electricity. The movement of the plane truss system is the elastic deformation resonating with the waves that interact with the pods and change the elevation and orientation of the pods at the maximum amplitude by the resonance of the deformation.

In the ocean, the waves vary the energy distribution in frequency, direction, and height over time. When the ocean wave energy conversion system operates in the ocean, the varying multidirectional irregular waves interact with the floating pods and impose excitation loads with other hydrodynamic effects in terms of added inertia, damping, and restoring forces. The ocean wave energy conversion system is designed to have its elastic deformation modes resonate with the excitation of the varying multidirectional irregular waves, which means the ocean wave energy conversion system will have increased elastic deformation (e.g., theoretical maximum magnitude elastic deformation) in response to the interactions with that dynamic ocean waves. The elastic deformation makes the truss bars deform and hereby the generators move to produce the electricity.

In addition, the ocean wave energy conversion system is scalable in terms of the size of the truss structure (e.g., number of trusses or truss bars, truss bar length, truss height, etc.), the number of pods, and the size of the system. For example, the ocean wave energy conversion system has a modular design, and the system may be scaled up or down by increasing the number of pods and the size of the truss system. Adjusting the size of the overall system has little effect on the efficiency of the system due to Froude scaling, however, increasing or decreasing the size of the system allows the scaled overall system to scale natural frequencies of the elastic deformation modes to resonate with different ocean waves at different deployment locations.

Furthermore, the ocean wave energy conversion system does not require fixed or strong boundary conditions. As the ocean wave energy conversion system extracts energy from waves in all directions, the ocean wave energy conversion system may be placed in more locations in the ocean and may be designed to move around within a more loosely defined area. Having a weak boundary condition such as slack mooring greatly reduces the initial and maintenance cost of the mooring system.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a block diagram that illustrates an ocean energy conversion system in accordance with aspects of the present disclosure;

FIGS. 2A-2E illustrate an example of an ocean energy conversion system in accordance with some aspects of the present disclosure;

FIGS. 3A-3D illustrates an example of the deformation of the ocean energy conversion system of FIGS. 2A-2E;

FIGS. 4A-4B illustrate an example of the deformation of an anchored ocean energy conversion system in accordance with some aspects of the present disclosure;

FIG. 5A depicts a graph illustrating the example efficiency of conventional wave energy conversion in terms of capture width ratio;

FIG. 5B illustrates one example of a conventional unidirectional fixed boundary surge wave energy converter of FIG. 5A;

FIGS. 6A-6C illustrates an example of an ocean energy conversion system in accordance with some aspects of the present disclosure and a corresponding graph depicting the efficiency of the ocean energy conversion system in terms of capture width ratio;

FIG. 7 depicts a series of graphs illustrating hydrodynamic performance and deformation resonance of different examples of ocean energy conversion systems in accordance with some aspects of the present disclosure;

FIG. 8 depicts a series of graphs illustrating optimal operating parameters for a given sea state of an example of an ocean energy conversion system in accordance with some aspects of the present disclosure;

FIG. 9 depicts a series of graphs illustrating an example of the influence of the dynamic operating parameters on the efficiency of different examples of an ocean energy conversion system in accordance with some aspects of the present disclosure;

FIG. 10 depicts a series of graphs illustrating the captured power and efficiency of an example of an ocean energy conversion system in accordance with some aspects of the present disclosure;

FIGS. 11A-11B illustrate an example of a pod design of the ocean energy conversion systems described herein and in accordance with some aspects of the present disclosure;

FIG. 12 illustrates a graph of an example of an ocean energy conversion system having multiple pod groups at multiple submergence depths in accordance with some aspects of the present disclosure;

FIGS. 13A-13B illustrate an example of a truss structure design of the ocean energy conversion systems described herein and in accordance with some aspects of the present disclosure;

FIGS. 14A-14B illustrate an example of a truss bar design and a truss connection design of the ocean energy conversion systems described herein and in accordance with some aspects of the present disclosure;

FIGS. 15A-15B illustrate an example of a truss bar design and a truss connection design of the ocean energy conversion systems described herein and in accordance with some aspects of the present disclosure;

FIG. 16 illustrates an example of a truss bar design and a truss connection design of the ocean energy conversion systems described herein and in accordance with some aspects of the present disclosure;

FIGS. 17A-17B illustrate an example of a truss bar design and a truss connection design of the ocean energy conversion systems described herein and in accordance with some aspects of the present disclosure;

FIGS. 18A-18B illustrate examples of truss-to-pod connection designs of the ocean energy conversion systems described herein and in accordance with some aspects of the present disclosure;

FIG. 19 illustrates an example rendering of a truss structure design of the ocean energy conversion systems described herein and in accordance with some aspects of the present disclosure;

FIG. 20 illustrates detailed renderings of components of the example of the truss structure design of FIG. 19;

FIGS. 21A-21H each illustrate an example of an ocean energy conversion system having different truss system designs and pod layouts in accordance with some aspects of the present disclosure;

FIGS. 22A-22B illustrate an example operation of an ocean energy conversion system positioned near a shoreline and water-based infrastructure in accordance with some aspects of the present disclosure;

FIG. 23 is a block diagram that illustrates a controller of an ocean energy conversion system in accordance with aspects of the present disclosure; and

FIG. 24 is a flowchart of system operation in accordance with aspects of the present disclosure.

FIG. 25 is a flowchart of system modification operations for deployment in accordance with aspects of the present disclosure.

FIG. 26 is a flowchart of system design operations for deployment in accordance with aspects of the present disclosure.

It should be understood that the drawings are not necessarily to scale and that the disclosed embodiments are sometimes illustrated diagrammatically and in partial views. In certain instances, details that are not necessary for an understanding of the disclosed methods and apparatuses or that render other details difficult to perceive may have been omitted. It should be understood, of course, that this disclosure is not limited to the particular embodiments illustrated herein.

### DETAILED DESCRIPTION OF THE INVENTION

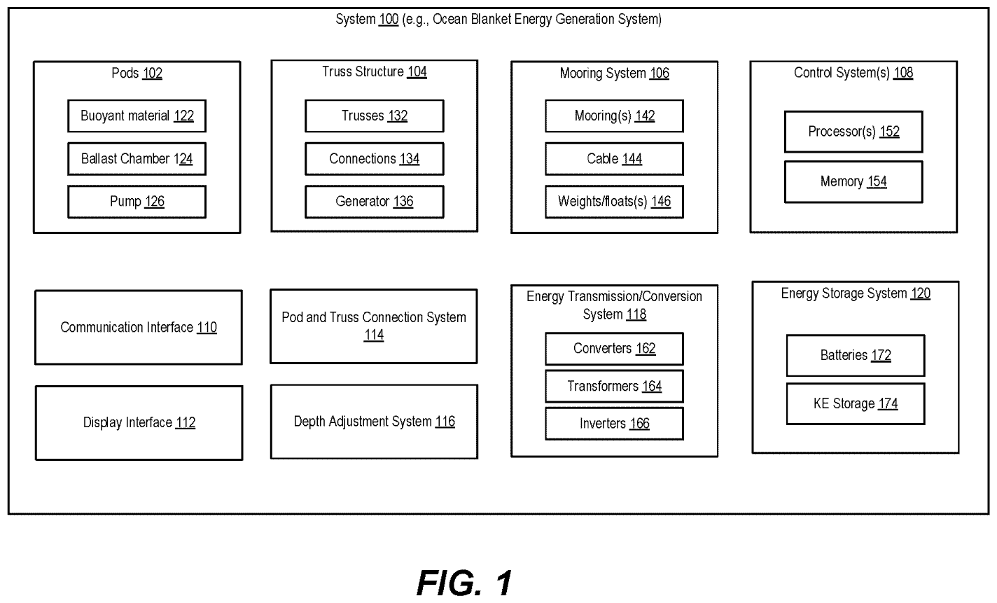

FIG. 1 is an example of system 100 (e.g., an ocean blanket energy conversion system). System 100 is configured to generate, such as harvest, kinetic, and potential energy from ocean waves. System 100 may be able to generate energy from ocean waves in all directions. As disclosed herein, system 100 may have a modular design and include a plurality of multi-directional wave-energy converters (WECs), which extract energy due to elastic deformation caused by ocean waves.

As illustrated in the example of FIG. 1, system 100 includes pod array 102, a truss structure 104, a mooring system 106, a control system 108, a communications interface 110, a display interface 112, a pod and truss connection system 114, a depth adjustment system 116, an energy transmission and conversion system 118, and an energy storage system 120.

System 100 includes a pod array 102 and pod array 102 is connected to and suspend the truss structure 104 in the water, as illustrated and described further with respect to subsequent figures.

Pod array 102 may include one or more pod-like structures configured to float or partially float and suspend at least a portion of the system. The pod array 102 may include or correspond to a plurality of pods where pods thereof are moveably coupled to one or more adjacent pods. Each pod of the pod array 102 may include buoyant material 122 and may be hollow or partially hollow. Additionally, in some implementations, one or more of the pods may include or be associated with (e.g., coupled to) a ballast chamber 124 configured to store seawater. The ballast chamber 124 may be configured to control the buoyancy of one or more pods of the pod array 102 by taking on seawater and releasing seawater. The ballast chamber 124 may include an inlet, an outlet, and have or be associated with a pump configured to pump seawater into and/or out of the ballast chamber.

Truss structure 104 includes a plurality of trusses 132, a plurality of connections 134, and one or more generators 136. The truss structure 104 may include or correspond to a space frame or system of repeating trusses that are flexible. In a particular implementation, the truss structure 104 is a tetrahedral truss structure 104 including a tetrahedron plane truss.

Each truss of the trusses 132 may include one or more truss members and optionally a generator of one or more generators 136. Each truss of the trusses 132 may be coupled to one or more other trusses of the trusses 132 via one or more connections 134. The connections 134 include one or more structural elements configured to couple one or more trusses of the trusses 132 together. Connections 134 may include pin-joint connections, ball-joint connections, or flexible connections (e.g., movable connections), or a combination thereof. The flexible connections may enable one or more trusses to move with respect to or relative to one or more second trusses of the trusses 132. As an illustrative example, the truss structure 104 may include components made of steel, such as carbon steel, to prevent corrosion from salt water.

One or more trusses of the plurality of trusses 132 may include truss members which are configured to flex and/or move relative to each other. The movement of one or more truss members may move a corresponding generator which then generates the electricity. Each generator may include a damper, such as a spring or tension cable configured to generate electrical energy. As the trusses of the truss structure move, individual generators may be compressed and/or extended and create energy.

Generator 136 may include or correspond to a linear alternator or a DC generator in some implementations. To illustrate, generator 136 (e.g., linear alternator) may be configured to generate alternating current based on back-and-forth motion. As an illustrative example, a member of a triangular truss may move back and forth linearly and in response to waves and generate energy by induction. The movement of the member of the triangular truss may cause the movement of a magnet relative to a conductor, or vice versa, to create an alternating current (AC) by induction. Similarly, generator 136 (e.g., DC generator) may generate direct current (DC voltage) based on the back-and-forth motion of a truss member for stacking DC power.

Mooring system 106 includes one or more moorings 142 configured to anchor to the system 100 and to boundary the system 100, such as the pods of the pod array 102 and truss structure 104. Each mooring of one or more moorings 142 may include a cable 144 and one or more weights and/or floats 146. The moorings 142 may be coupled to anchors on the seafloor or other objects (e.g., shoreline, lighthouse, oil derrick, vessel, offshore wind turbine, etc.).

Control system 108 is configured to control one or more operations of the system 100. Control system 108 may include a processing system. For example, the control system 108 may include one or more processors 152 and one or more memories 154. The one or more memories 154 may store instructions which when executed by the processor(s) 152 cause the processor(s) 152 to perform one or more actions and/or cause the system 100 (e.g., components thereof) to perform one or more actions.

Communications interface 110 includes a communication device configured to communicate with one or more external devices or systems, one or more devices of the system 100, or both. For example, the communications interface 110 may include or correspond to a wireless communications interface configured to wirelessly communicate data with one or more external devices or devices of the system 100. To illustrate, the communications interface 110 may include a cellular interface, a satellite communications interface, a Wi-Fi interface, a Bluetooth interface, etc.

Display interface 112 includes a display device configured to output or display information regarding the system 100. In some implementations, the display interface 112 may include or correspond to a control interface and be coupled to or associated with the control system 108. In other implementations, the system 100 may not have a display interface, and display and/or control interfaces are remote to the system 100.

Pod and truss connection system 114 includes a structure configured to couple the pods of the pod array 102 to the truss structure 104. For example, the pod and truss connection system 114 may include one or more support members, one or more connection elements (e.g., pod-to-truss interconnects), etc. The connection elements may include pin joints, ball joints, flexible joints, or a combination thereof, to enable movement by the pods from ocean waves to be translated to the truss structure 104 and generators 136 thereof.

Depth adjustment system 116 includes or corresponds to a system configured to adjust a depth of the system 100. For example, the depth adjustment system 116 may be configured to control a depth of one or more pods of the pods 102, one or more trusses of the truss structure 104, or both. To illustrate, in some implementations, the system 100 may include one or more groups or subsets of pods and corresponding trusses at different depths and may be configured to adjust a depth of each group, and thus an overall shape of the system 100. As an illustrative example, the system 100 may be adjusted from a generally convex shape to a generally concave shape with respect to the surface of the water.

Energy transmission and conversion system 118 may be configured to control the generators' loads and to convert generated electricity for storage and/or transmissions. For example, the generators 136 can change the loads in terms of stiffness and damping so as to produce the maximum electricity, and the electricity generated may be of one type (e.g., AC) and may be converted to another type (e.g., DC) for storage or transmission). As another example, the generators 136 may generate DC and the system 100 may transmit the DC after a conversion process. To illustrate, a first converter device or system (e.g., rectifier and inverter) converts the generated DC to AC, and a second converter device or system (e.g., rectifier and inverter) converts the converted AC to back to DC for transmission, such as long-distance transmission. In implementations where DC is generated by the generators 136, a small amount of power may be converted from DC to AC for powering the system 100, such as control systems thereof.

In the example of FIG. 1, the energy transmission and conversion system 118 includes one or more converters 162, one or more transformers 164, and one or more inverters 166. One or more converters 162 may include current controllers, voltage converters, frequency converters, or a combination thereof. A current controller may include or correspond to an electric controller configured to adjust the current of the generators. A voltage converter may include or correspond to an electric power converter device or circuitry configured to adjust the voltage of an electrical power source (e.g., the generated electricity from the generators 136). A frequency changer or frequency converter may include or correspond to an electronic or electromechanical device or circuitry configured to convert AC from one frequency to another frequency. In some implementations, the frequency converter may also change the voltage. Additionally, or alternatively, the one or more converters 162 may include or correspond to a DC-to-DC converter. The DC-to-DC converter may include or correspond to an electronic or electromechanical device or circuitry (e.g., electrical power converter) configured to convert a source of DC from one voltage level to another.

One or more transformers 164 may include or correspond to an electronic device or circuitry configured to transfer electrical energy between circuits. A transformer may include a passive component configured to transfer electrical energy from one electrical circuit to another circuit, or multiple circuits. Additionally, one or more of the transformers may be configured to change AC voltage levels, such transformers being termed step-up or step-down types to increase or decrease voltage, provide circuit isolation, or a combination thereof.

One or more inverters 166 may include or correspond to a power inverter (also referred to as inverter or invertor). The power inverter may include or correspond to an electronic device or circuitry configured to convert DC to AC.

Energy storage system 120 includes one or more energy storage devices configured to store energy generated by the generators. The energy storage devices may include or correspond to electrical energy storage devices, such as batteries 172, or kinetic energy storage devices, such as kinetic energy storage 174. As illustrative, non-limiting examples of kinetic energy storage, kinetic energy storage 174 may include or correspond to spring storage systems, compressed air storage systems, flywheel energy storage systems, hydraulic accumulator storage systems, pumped-storage systems (e.g., pumped storage hydropower), or a combination thereof.

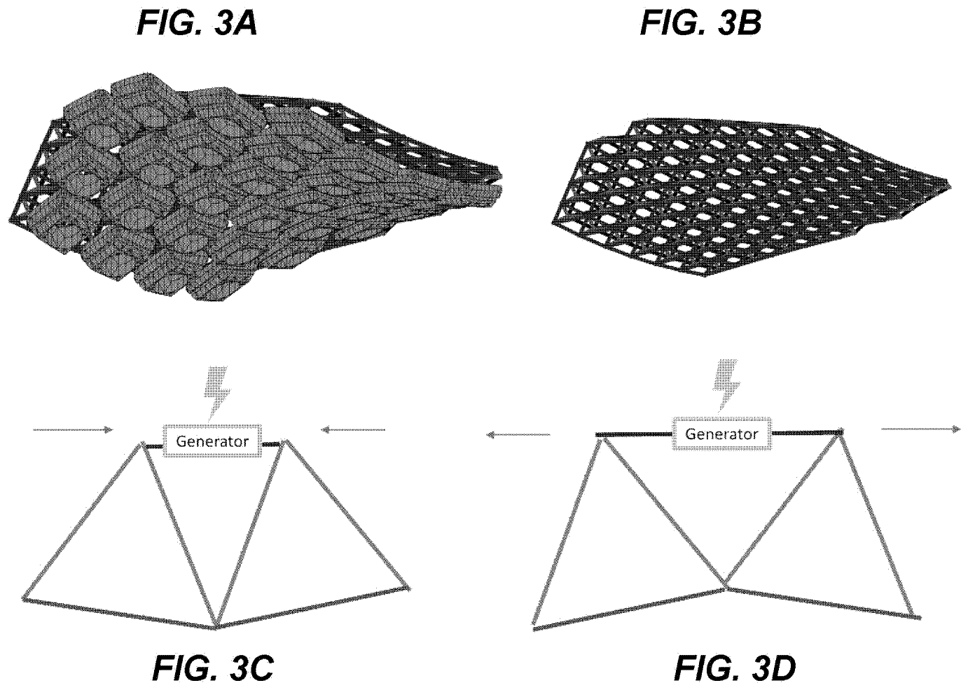

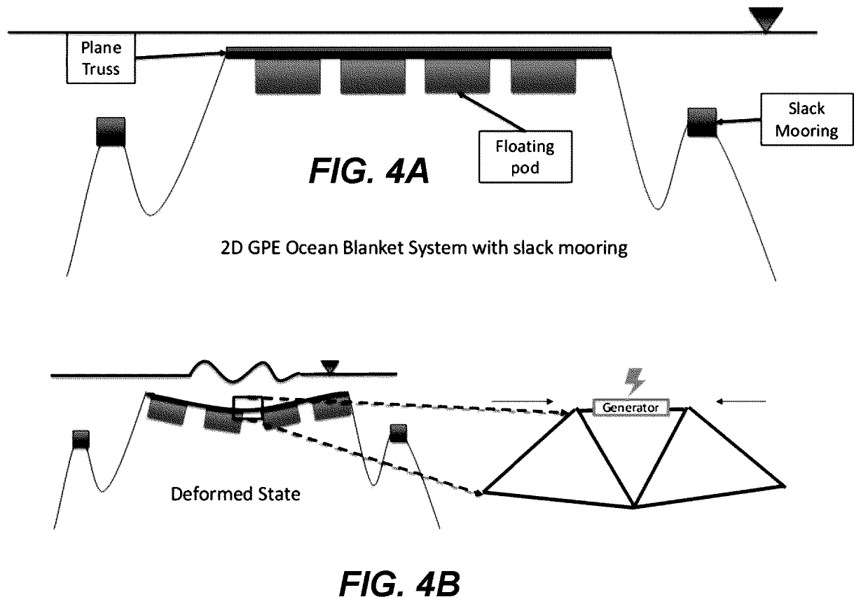

Operation of system 100 is described with reference to subsequent figures, including at least FIGS. 3A-4B. Accordingly, system 100 enables efficient energy generation from multi-directional waves.

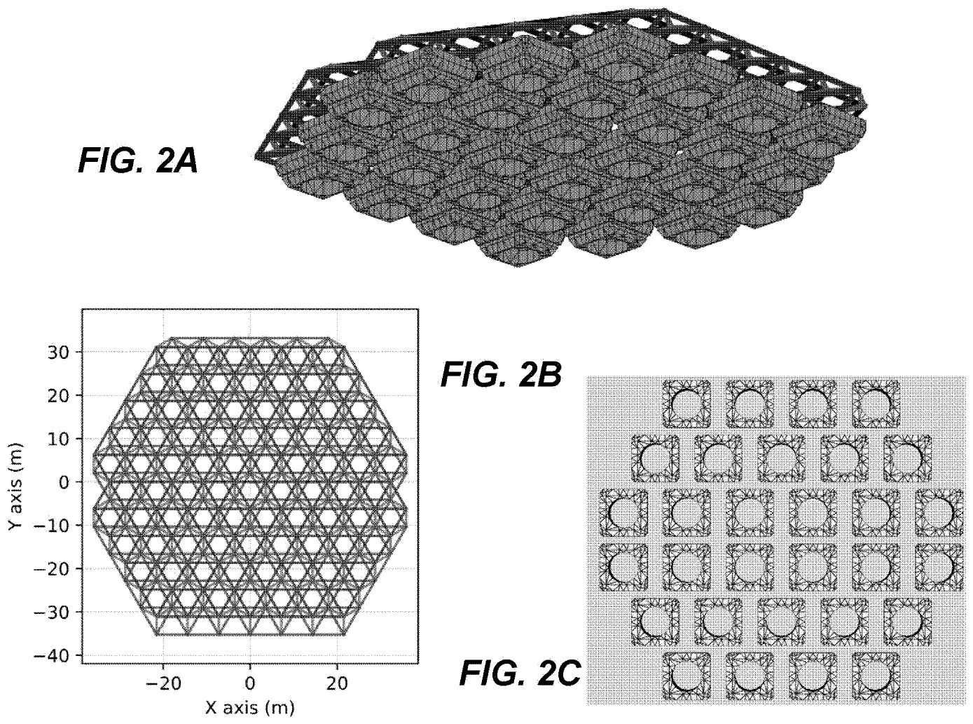

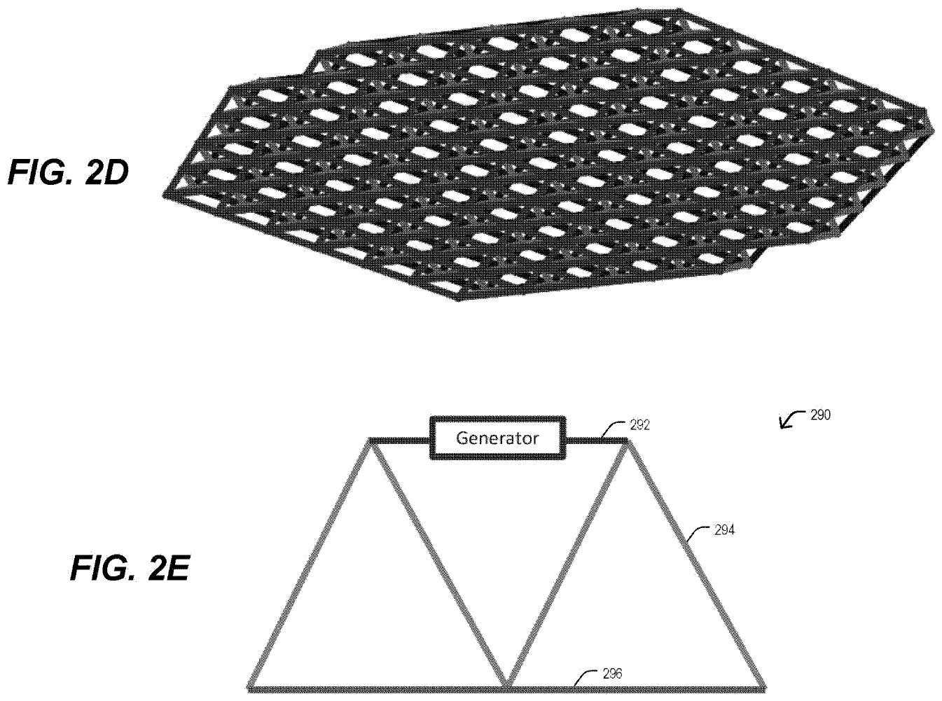

FIGS. 2A-2E illustrates an example of a pod array and truss system of an ocean energy blanket system, such as system 100 of FIG. 1. FIG. 2A depicts a truss structure layout assembled with a pod array arranged in a hexagonal arrangement (a hexagonal pod layout). FIG. 2B further illustrates the truss structure, and FIG. 2C further illustrates the pod layout design and the design of the individual pods. FIG. 2D further illustrates an isometric view of the truss structure illustration of FIGS. 2A and 2B, and FIG. 2E further illustrates one example truss and generator of the truss structure of FIG. 2D.

Referring to FIG. 2A, an exemplary design of a truss structure and a pod array of an ocean energy blanket system is illustrated. The truss structure is connected to the pod array and is supported in the water by the pod array. The pod array may be designed and arranged to capture energy from ocean waves, including waves in any and all directions and from irregular waves. For example, the pod array may move, rise, and fall, with incoming waves from any direction, and thus cause one or more trusses of the truss structure to move and deform, such as expand and/or contract, due to the movement of the pods. The expansion and contraction of truss members or elements of the truss structure may be used to generate energy, as illustrated and described further with reference to FIGS. 3A-3D.

Referring to FIG. 2B, an exemplary design of the truss structure is illustrated in a top view. The truss structure includes three layers depicted as different colors in FIG. 2B. The truss structure includes a top layer of top truss bars, a middle layer of truss web bars, and a lower layer of truss bottom bars. The top and bottom truss bars may be considered planar bars and in plane with the surface of the water. The truss web bars may correspond to vertical and/or angled bars which are connected to the top and bottom truss bars together and form a web of individual trusses. In FIG. 2B, the top truss bars are red, the bottom truss bars are blue, and the truss web bars are green.

Referring to FIG. 2C, a top view of the pod layout of the illustration of FIGS. 2A and 2B is depicted. FIG. 2C depicts an overall layout of the pods, a design or shape of the pods, and a spacing of the pods. As illustrated in FIG. 2C, the pods are generally square or rectangular shaped and have a circular cutout or through hole passing from top to bottom.

Referring to FIG. 2D, an isometric view of the truss structure illustration of FIGS. 2A and 2B is depicted. FIG. 2D represents a simplified illustration of the truss structure, which is a tetrahedron plane truss. Additional images and renderings of the truss structure designs are illustrated further.

In FIG. 2D, the red lines indicate the top bars or elements of the truss structure. In some implementations, the top bars or elements of the truss structure include one or more generators, as illustrated and described further with reference to FIG. 2E.

Referring to FIG. 2E, FIG. 2E illustrates one example of truss 290 of the truss structure. As illustrated in FIG. 2E, the truss 290 includes a generator 292 on or as a top truss bar, multiple truss web bars 294 (e.g., vertically arranged truss members), and a truss bottom bar 296. Each of the truss elements of truss 290 may include one or more connections to other trusses of the structure and/or to pods of the system. For example, the truss structure may include truss web connector bars or elements to connect one or more first truss webs of a first truss to one or more second truss webs of a second truss. As another example, the truss structure may include pod connector bars or elements to connect one or more truss bottom bars to one or more pods of the pod array of the system.

FIGS. 3A-3D illustrates an example of the deformation of the ocean energy blanket system of FIGS. 2A-2E. FIG. 3A depicts the deformation of the truss structure and the array of pods of FIG. 2A. FIG. 3B further illustrates the truss structure and deformation depicted in FIG. 3A. FIGS. 3C and 3D illustrate deformation examples of the truss structure of FIG. 2D for the deformation depicted in FIG. 3A.

Referring to FIG. 3A, an isometric view of the truss structure and the pod array of the ocean energy blanket system under deformation caused by a wave is illustrated. As illustrated in FIG. 3A, the pods of the system are buoyant and float, which suspends the truss structure in the water. As waves interact with the pods and pass through the pods, the pods may experience elevation shifts as they float in the water which has varying elevations and elevation changes from passing waves. The pod array may experience elevation changes of varying degrees at different locations across the pods and system, and the pods may also experience orientation changes (e.g., tilting, tipping, twisting, etc.) as waves pass through the system. For example, one or more first pods of the pod array may experience a higher degree of elevation change in one area than one or more second pods of a second area. Additionally, or alternatively, one or more first pods of the pod array may experience tilting/tipping (or a greater degree thereof) in one area than one or more second pods of a second area.

Referring to FIG. 3B, FIG. 3B illustrates an isometric view of the truss structure under deformation. As illustrated in FIG. 3B, the truss structure may experience deformation of varying degrees at different locations across the truss structure. For example, the truss structure may experience a higher degree of deformation in one area than another of a different type of deformation at the left and right edges of FIG. 3B as in the example of FIG. 3B. The truss structure may also deform as waves pass through the system, from the deformation and/or movement of the pods.

Referring to FIG. 3C, FIG. 3C illustrates an example of truss contraction. In the example, of FIG. 3C, the top truss bar and/or generator moves linearly inwards or contracts and generates electricity. Referring to FIG. 3D, FIG. 3D illustrates an example of truss expansion. In the example, of FIG. 3D, the top truss bar and/or generator moves linearly outwards or expands and generates electricity. The pod array, the truss structure, and their connections can be designed to result such that the whole system has the deformation that is capable of resonating with varying multidirectional irregular waves.

FIGS. 4A and 4B illustrate a depiction of the mooring and anchoring of an ocean energy blanket system and the deformation of the ocean energy blanket system, such as system 100 of FIG. 1. FIG. 4A illustrates a simplified depiction of the ocean energy blanket system attached to a slack mooring. FIG. 4B illustrates the deformation of the ocean energy blanket system as waves pass through the ocean energy blanket system.

Referring to FIG. 4A, FIG. 4A illustrates a simplified side view of the ocean energy blanket system attached to a slack mooring. The slack mooring may include a line and one or more floats and/or weights. As illustrated in the example of FIG. 4A, the ocean energy blanket system is coupled to two lines, one on each side. Each line has a float or is coupled to a float and coupled to a weight or an anchor (not shown in FIG. 4A). The slack mooring may enable the ocean energy blanket system to remain in one general location, and may also enable movement within that location, such as lateral movement and vertical movement. The slack mooring may provide a loose boundary condition as opposed to strong boundary conditions used and needed by conventional WECs. Moreover, the utilization of the Buoyancy control device allows for control over the submergence depth of the ocean energy blanket system. This adaptability enables the system to operate either at the free surface or in a submerged configuration, offering optimization of performance and facilitating various operational requirements.

Referring to FIG. 4B, FIG. 4B illustrates a simplified side view of the ocean energy blanket system in a deformed state as a wave passes through. As illustrated in the example of FIG. 4B, the ocean energy blanket system deforms to have a concave shape as the wave passes through and trusses thereof generate electricity through contraction. The slack mooring enables the ocean energy blanket system the flexibility to move with the wave (e.g., the system to move within a general area of the water and the individual pods to move up and down) and still be contained or configured to a general area.

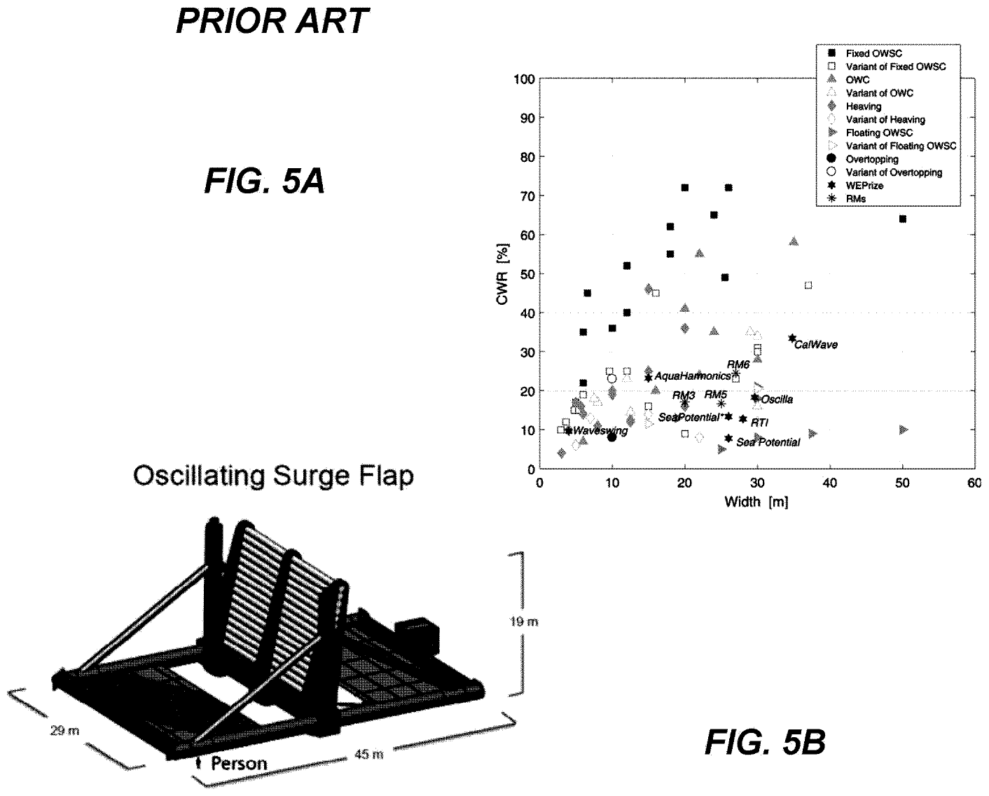

FIGS. 5A and 5B illustrate capture width ratios (CWRs) of conventional wave energy conversion devices and one example of a large-scale wave energy converter to be placed on the seafloor. FIG. 5A includes a table depicting the capture width ratios of wave energy conversion devices plotted against the width of the devices. FIG. 5B illustrates an oscillating surge flap-type wave energy converter.

Referring to FIG. 5A, the table depicts CWR for multiple conventional wave energy conversion devices and corresponding sizes thereof, for a single wave direction. For example, multiple maximum CWRs may be illustrated for one type of device where each CWR corresponds to a particular size or width of the device or system. Generally, the lower CWR values in FIG. 5A corresponds to conventional wave energy conversion devices which attempt to capture energy from ocean waves in more than one direction or soft mooring systems like slack mooring lines, and the higher CWR values correspond to conventional ocean energy extraction devices which extract energy from waves in a single direction and requires strong boundary conditions. To illustrate, the fixed oscillating surge flap type device, shown in FIG. 5B, produces the highest efficiency and CWR. However, the fixed oscillating surge flap-type device requires strong boundary conditions and generates no energy from waves outside of a narrow capture direction.

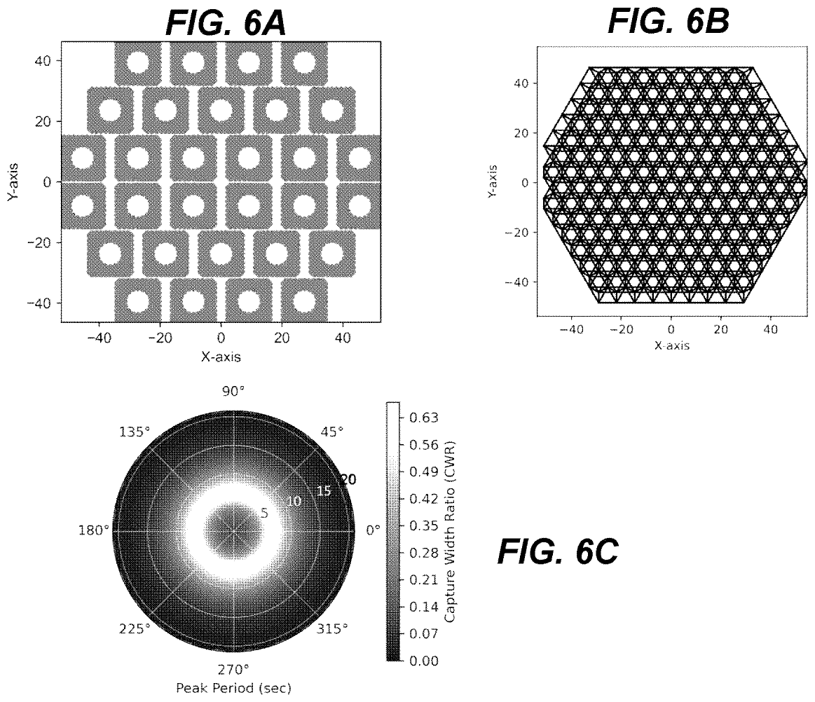

FIGS. 6A and 6C illustrate a capture width ratio of an exemplary design of the ocean energy blanket systems described herein. FIGS. 6A and 6B illustrate pod and truss designs of the example design of the ocean energy blanket, and FIG. 6C illustrates the CWR example design of the ocean energy blanket with respect to the peak period.

Referring to FIG. 6A, FIG. 6A illustrates an example pod design and layout for the example CWR of FIG. 6C. Referring to FIG. 6B, FIG. 6A illustrates an example truss structure design and layout for the example CWR of FIG. 6C. In the example design of FIGS. 6A and 6B, a hexagonal overall pod layout design is illustrated which includes square-shaped pods with small circular cutouts. For the example design of FIGS. 6A and 6B, the pod length is approximately 13.7 meters, the pod breadth is approximately 13.7 meters, and the pod height is approximately 3.2 meters. The pod-to-pod spacing is approximately 4.5 meters. The entire length of the pod array is approximately 105 meters, and the entire breadth of the pod array is 92.5 meters. The height of the pod array is similar to the pod height, approximately 3.2 meters, and the submergence depth is approximately 1 meter.

In FIGS. 6A and 6B, the top and bottom truss bars have a length of approximately 7.3 meters, the truss web bars have a length of approximately 4.2 meters, and the truss structure height is approximately 0.25 meters. The cross-section area is approximately 3.55e−2 meters squared. The system has a material modulus of 2.00e11 newtons per meter, a spring coefficient of 0 newtons per meter, and a dashpot coefficient of 3.00e9 newton seconds per meter. The maximum CWR of the example of FIGS. 6A and 6B is approximately 0.66 for waves with a 7 second peak period and for waves incoming at 90 degrees. A maximum or optimal wave direction, such as 90 degrees in the example of system FIGS. 6A and 6B, corresponds to a mean or average direction of the waves with respect to local coordinate of the system at which the capture width ratio is highest or maximized.

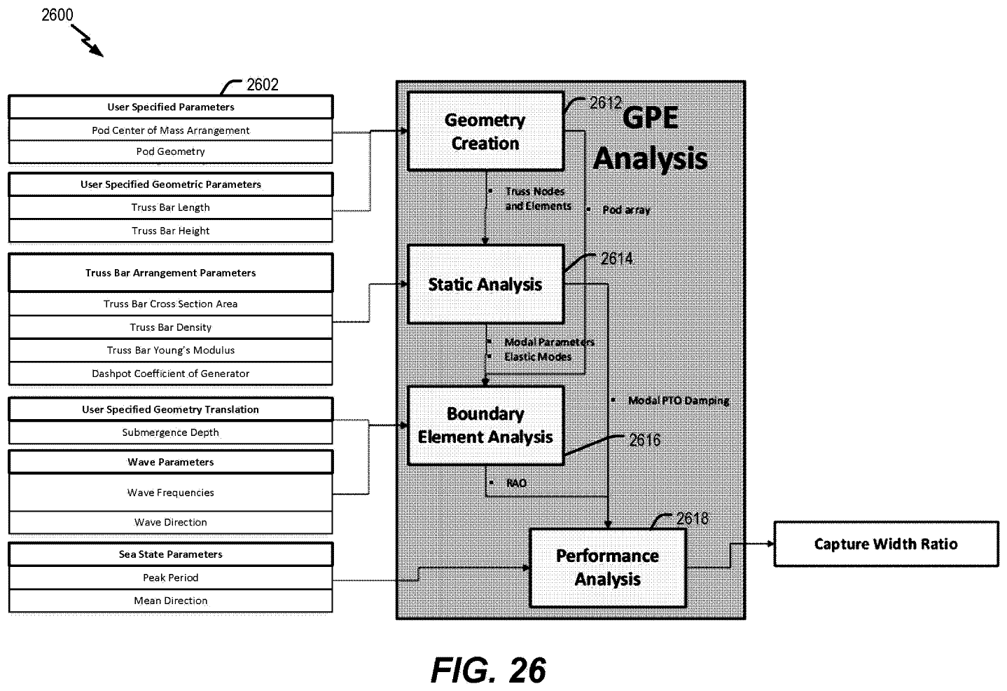

Referring to FIG. 6C, FIG. 6C illustrates a graph depicting CWR values for wave peak periods, in seconds. For the example design illustrated in FIGS. 6A and 6B, the system has a CWR of up to 65% for irregular waves, i.e., waves coming in any direction. The CWR value of up to 65% is constant across all directions of the waves. As compared to the unidirectional devices shown in FIGS. 5A and 5B, the designs herein enable higher CWR and are consistent in all directions. The example design illustrated in FIGS. 6A and 6B was designed for sea state conditions of a 7 second peak period, and the design in FIGS. 6A and 6B may be adjusted based on the design methodology shown and described with reference to FIG. 26.

The graph of FIG. 6C also depicts CWR for different wave peak periods. In the graph, the peak period increases radially outward to a value of 20 (sec). The example design has a CWR of nearly 65% for waves around 5 sec high which decreases with peak period. By changing the size scale of the ocean energy blanket system, we can adjust which wave peak period to increase CWR (e.g., increase maximum and/or average CWR).

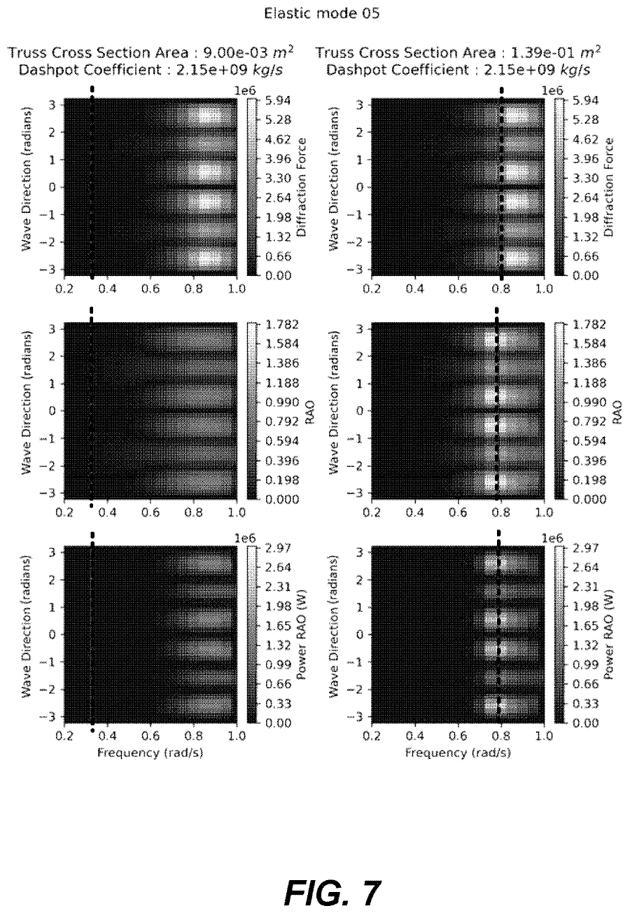

FIG. 7 illustrates a series of graphs depicting the performance of example designs of the ocean energy blanket systems described herein, such as the design of FIGS. 6A and 6B. FIG. 7 illustrates the performance of designs of two similarly shaped systems with different system parameters, where each system has different truss cross-section areas. The left side of FIG. 7 illustrates a set of three graphs for a first truss structure with a smaller truss cross-section area as compared to a second truss structure corresponding to the set of three graphs for the right side of FIG. 7. Each design has the same dashpot coefficient. The truss cross-section area represents the cross-section area of a bar of the truss system. The dashpot coefficient represents the damping coefficient of an individual linear generator.

In FIG. 7, each design is associated with three graphs that plot wave direction against frequency, and each graph also illustrates diffraction force, deformation response amplitude operator (RAO), and power RAO. The graphs depict simulation results for each design in elastic mode #5. Elastic mode represents the deflection of the entire body at its natural frequency. The total motion of the body can be represented by a superposition of the elastic modes of all the natural frequencies of the body (e.g., floating pods, truss, and overall system). In testing the designs of the systems described herein, elastic modes may be inputted in a boundary element method to compute a representative RAO of the system for a given wave frequency and wave direction. Boundary element computational methods are known in the art, such as in “Kang, H. Y., and M. H. Kim. “Time-domain hydroelastic analysis with efficient load estimation for random waves.” International Journal of Naval Architecture and Ocean Engineering 9.3 (2017): 266-281, which describes the use of different elastic modes to compute the motion of a floating body in random waves.

The diffraction force corresponds to hydrodynamic forces on the floating body, which results from the interaction with the regular ocean waves. On the perspective of energy conversion, the diffraction force indicates how much wave energy is converted to the floating body. The larger diffraction force means more wave energy is transferred to the floating body motion.

The deformation RAO corresponds to the motion amplitude of the elastic deformation, elastic mode #5 in this figure, in response to the regular wave at each frequency and heading with the unit wave amplitude, which represents how large the deformation will occur in response to each regular wave. Power RAO corresponds to power in watts produced from the linear generators that undergo those deformation responses for each regular wave.

In the top graphs, diffraction force graphs, the results of each design are similar for diffraction force, which means the first energy conversion to the excitation is similar in both designs. In the middle graphs, RAO graphs, the results of each design are related to the right side or second design with larger truss cross-section areas having higher RAOs for similar wave directions and frequencies, which means the second design has resonance that produces such a large response compared to the first design without the resonance. The larger response means more mechanical energy is extracted from the wave. In the bottom graphs, power RAO graphs, the results of each design are related to the right side or second design with a larger truss cross-section area having higher power RAOs for similar wave directions and frequencies, which corresponds to the larger response or mechanical energy converted to the greater electricity. The vertical red line in each graph represents modal natural frequency. The graphs in FIG. 7 illustrates when the resonance frequency aligns with the maximum diffraction force, the resulting RAO and power RAO are amplified. Once the individual elements are tuned or optimized for increased efficiency or CWR, the system may be scaled up or down by adding or removing the efficient or tuned modular elements or scaling the system dimension.

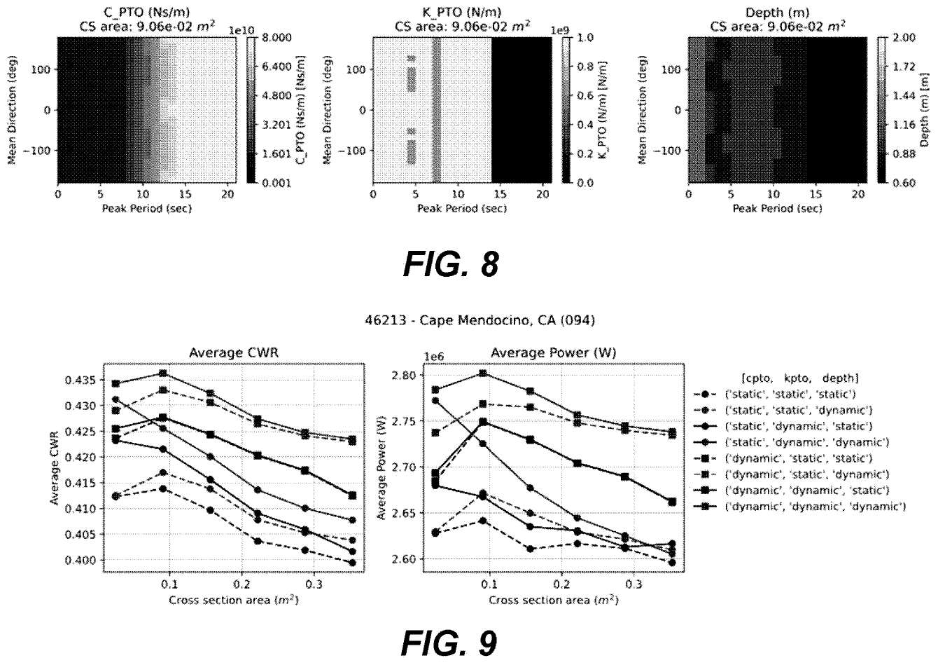

FIG. 8 illustrates a series of graphs depicting the performance of example designs of the ocean energy blanket systems described herein, such as the design of FIGS. 6A and 6B. FIG. 8. depicts a set of three graphs for a particular design illustrating (a) power-take-off damping, (b) power-take-off stiffness, and (c) submergence depth. In the example of FIG. 8, the system with a truss cross-section area of 0.09 m². The graphs of FIG. 8 were generated with respect to the peak period and mean direction of random waves. The graphs in FIG. 8 indicate optimal parameters for power-take-off damping, power-take-off stiffness, and submergence depth and depict trends for adjusting power-take-off damping, power-take-off stiffness, and submergence depth to increase CWR and power generated for a given truss size and design.

As illustrated in the left graph for power-take-off damping, the optimal power-take-off damping generally increases for longer peak periods showing that CWR increases with the increase of PTO damping at higher peak periods. As illustrated in the center graphs for power-take-off stiffness, the optimal power-take-off stiffness generally increases for shorter peak periods showing that maximum CWR is observed at the higher PTO stiffness at shorter peak periods. As illustrated in the right graph for submergence depth by lighter colors, the higher CWR is observed when the depth is shallower or closer to the surface for shorter peak periods. Additionally, the higher CWR is captured when deeper depths are used for longer peak periods. As illustrated, higher CWR is captured by increasing depth with increasing peak periods or reducing depth with reducing peak periods.

FIG. 9 illustrates a series of graphs depicting the performance of example designs of the ocean energy blanket systems described herein, such as the design of FIGS. 6A and 6B. FIG. 9 illustrates two graphs, a first graph of the average CWR of the system plotted against the (truss) cross-section area, and a second graph of the average captured power of the system plotted against the (truss) cross-section area.

In FIG. 9, a circular marker represents static power-take-off damping, and a rectangular marker represents dynamic power-take-off damping. In FIG. 9, a dashed line represents static power-take-off stiffness, and a solid line represents dynamic power-take-off stiffness. In FIG. 9, the color red represents static submergence depth, and the color blue represents dynamic submergence depth. Based on that a wave energy converter system is deployed at an ocean site where the sea states change in terms of the peak period, significant wave height, and mean heading, the dynamic means the value of each property is adjusted to be optimum at each sea state whereas the static means the value of each property is constant for any sea states.

As illustrated in FIG. 9, dynamic submergence depth produced higher CWR and higher captured power, as compared to static submergence depth. As illustrated in FIG. 9, dynamic power-take-off damping produced higher CWR and higher captured power, as compared to static power-take-off damping. As illustrated in FIG. 9, dynamic power-take-off stiffness produced higher CWR and higher captured power, as compared to static power-take-off stiffness. As illustrated by the change in CWR for submergence depth, the performance of the system can be optimized in real-time by dynamically controlling the submergence depth, power-take-off damping, and power-take-off stiffness, such as by the depth adjustment system of FIG. 1. To illustrate, mooring lines and/or ballast tanks may be adjusted to control depth of one or more pods or the system as a whole.

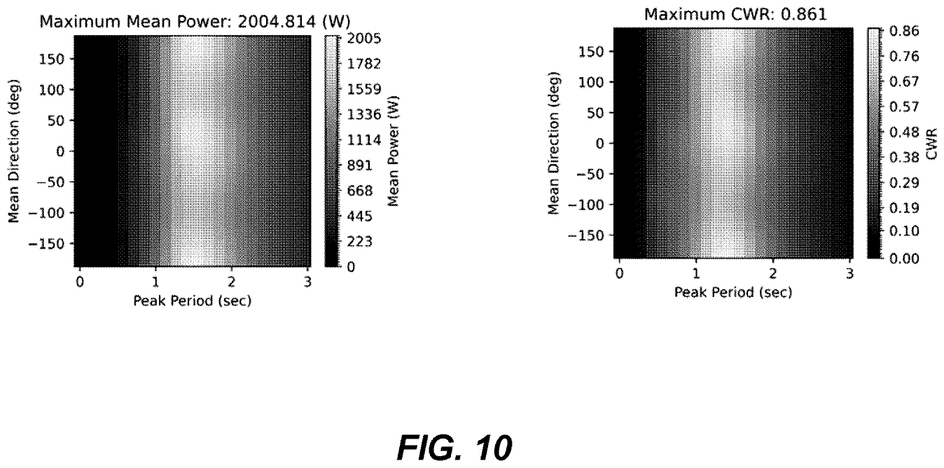

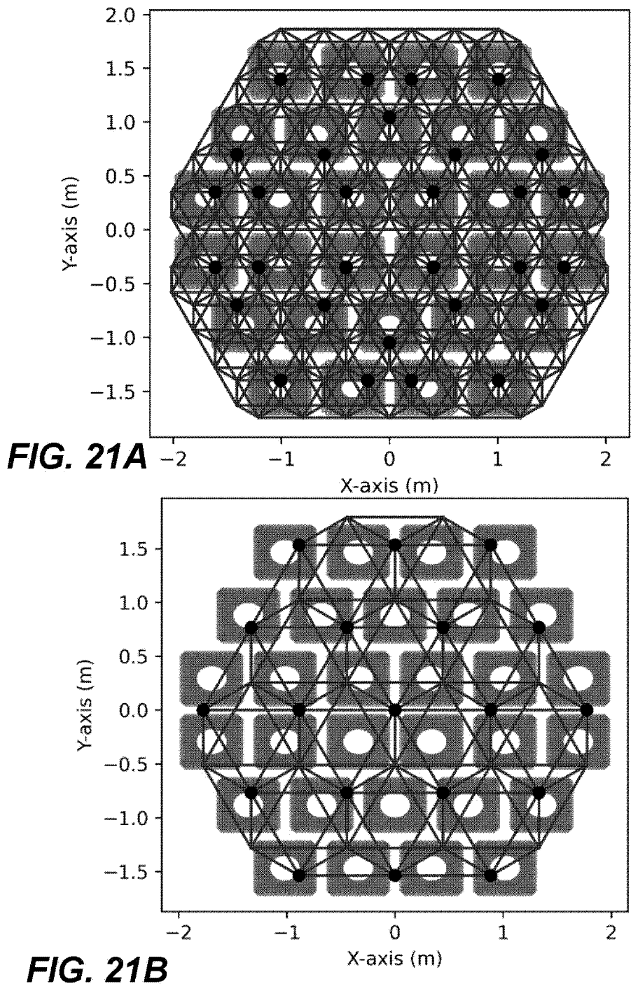

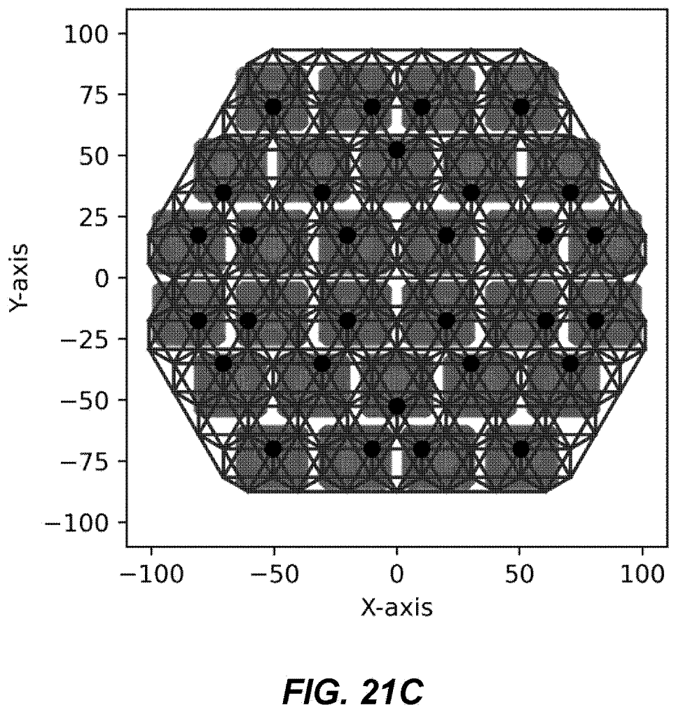

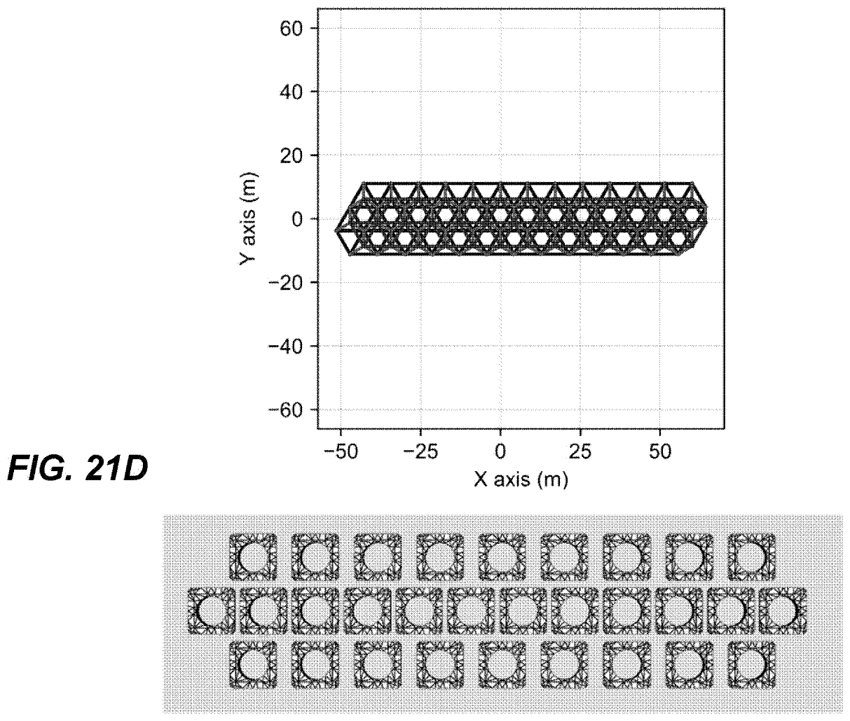

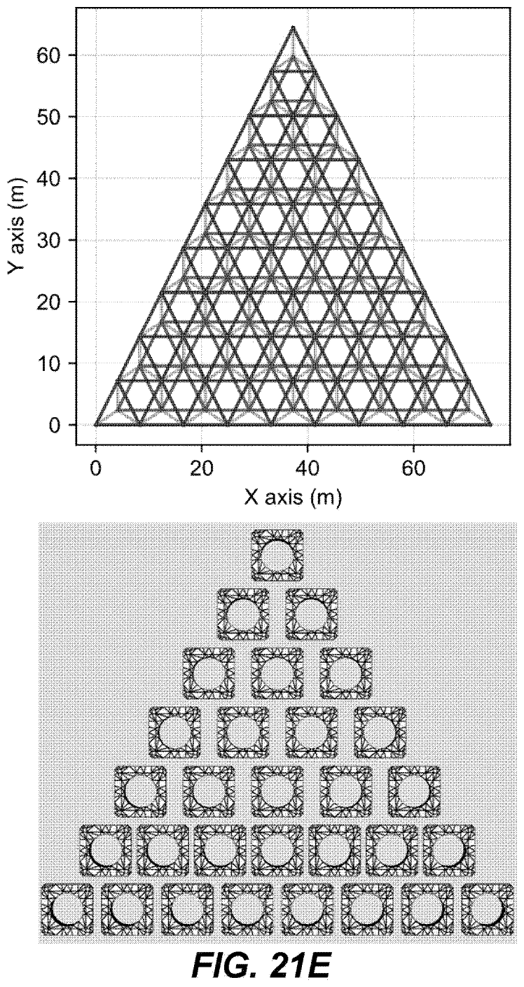

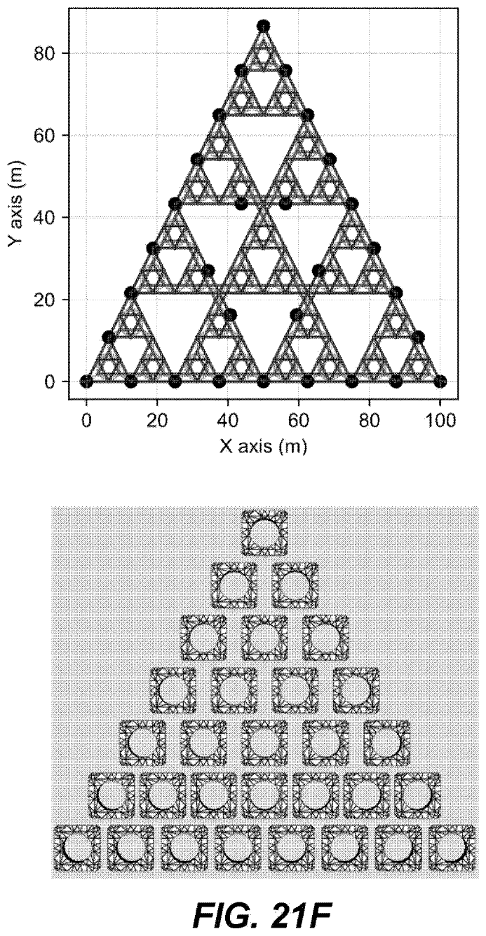

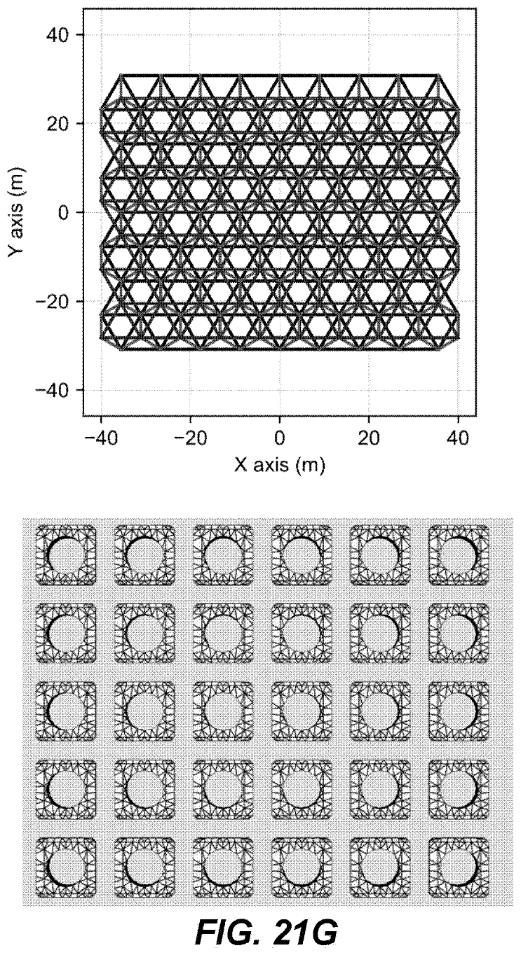

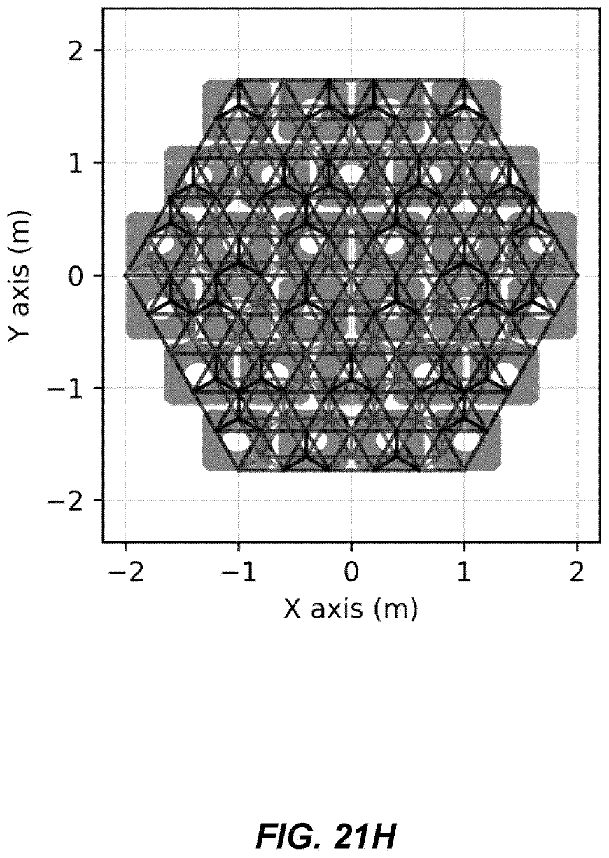

FIG. 10 illustrates a series of graphs depicting the performance of example designs of the ocean energy blanket systems described herein, such as the design of FIGS. 6A and 6B or FIG. 21H. FIG. 10 illustrates two graphs, a first graph of the maximum mean power of the system plotted against mean wave direction and peak period, and a second graph of the average CWR of the system plotted against mean wave direction and peak period.

In FIG. 10, mean wave direction is illustrated on a vertical axis in degrees, and the peak period of the waves is illustrated on a horizontal axis in seconds. The left side graph depicts higher maximum mean powers as lighter (e.g., yellow) colors, and the right side graph depicts higher CWR as lighter (e.g., yellow) colors. In the graphs of FIG. 10, the design has higher performance for a peak period range between 1 to 2 seconds and shows consistent performance across waves in all directions.

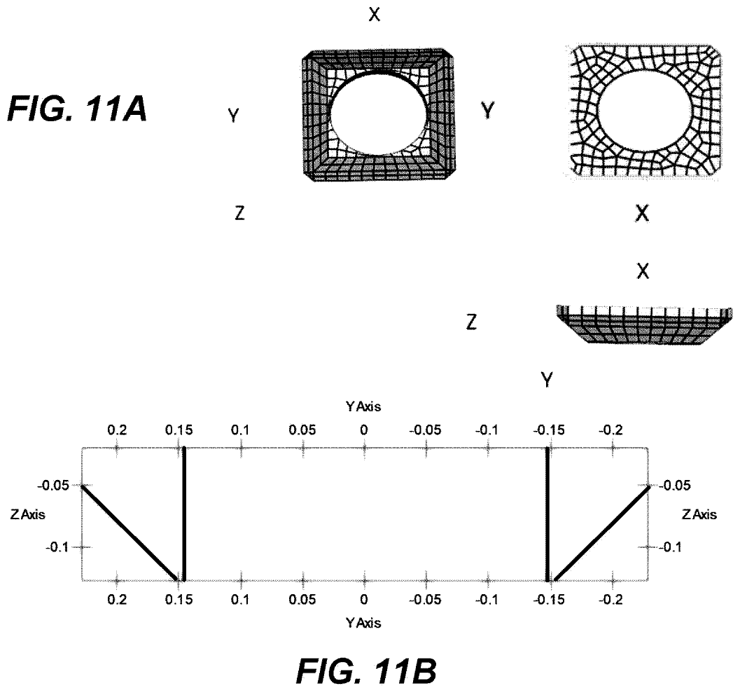

FIG. 11A illustrates top, bottom, and side views of an example design of a single pod of a pod array of the system. As illustrated in FIG. 11A, the bottom view is pictured top left, the top view is illustrated top right, and the side view is pictured bottom right.

FIG. 11B illustrates a mid-section profile of the example design of the pod of FIG. 11A. As illustrated in FIG. 11B, the mid-section profile of the example design has a circular cut-out or through-hole, chamfered edges, and an angled exterior that is sloped inwards from top to bottom.

In the example of FIGS. 11A and 11B, the pods have a length of 0.528 m, a breadth of 0.457 m, a height of 0.106 m, and a spacing of 0.150 m. The dimension in the example of FIGS. 11A and 11B have a scale factor of 1/50 (0.020). The dimensions of FIG. 11B are directed to one example embodiment. Other embodiments are described further herein, and the aspects described herein include systems of varying dimensions and components of various sizes.

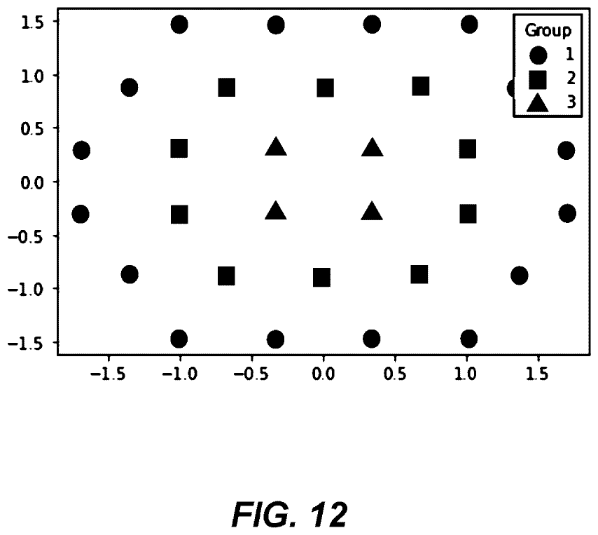

FIG. 12 illustrates an example of pod grouping and pod depth. As explained above, pods of the system may be grouped with one another for depth control and/or energy generation. For example, pods may be grouped nearby or by adjacent pods, and/or by layer.

FIG. 12 illustrates an example of a layer or ring-like grouping where an outermost ring or group of pods is designated as a first group (group 1), a middle ring or group of pods is designated as a second group (group 2), and an innermost ring or group of pods is designated as a third group (group 3).

Each group of pods may be associated with a specific depth. For example, each group of pods may be set up to have a particular depth. To illustrate, the first group may be set deeper than one or more of the other groups to form a concave shape with respect to the water surface or may be set shallower than one or more of the other groups to form a convex shape with respect to the water surface.

In some implementations, the depths of the groups of pods or individual pods may be adjusted, as described with reference to FIG. 1. For example, a controller may adjust the amount of water in a ballast tank in or associated with one or more pods to control a depth of the pod. Although the pods are described as having a certain depth, the submergence depth is measured from the top of the pod to the water surface.

Although the pods or groups of pods may be adjusted, the pods may be set or configured to have the same depth. In some such implementations, the groups of pods may be used for other purposes. For example, pods of a single group may be connected to each other or the truss structure in a first manner (e.g., pin-joint or semi-flexibly), and the pods of another group may be connected to each other or to the truss structure in a first manner (e.g., pin-joint, semi-flexibly, or flexibly) and to the pods of the first group in a second manner (e.g., pin-joint, semi-flexibly, or flexibly) to enable the groups to behave differently from one another while experiencing the same wave.

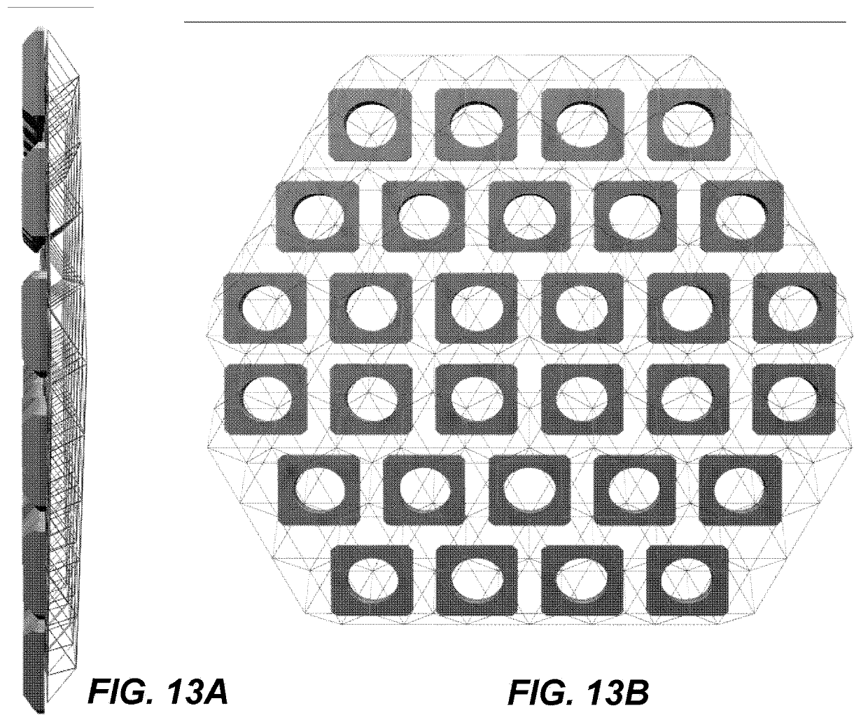

FIGS. 13A and 13B depict top and side view pictures of an example of a truss structure, such as truss structure 104. FIG. 13A illustrates a side view of the truss structure, and FIG. 13B illustrates a top view of the truss structure. In the example of FIGS. 13A and 13B, the truss structure is a tetrahedron truss structure or space frame. Additionally, truss structure dimensions of height, width, and length are also illustrated. Subsequent figures describe elements and connections between truss members or bars of the truss structure.

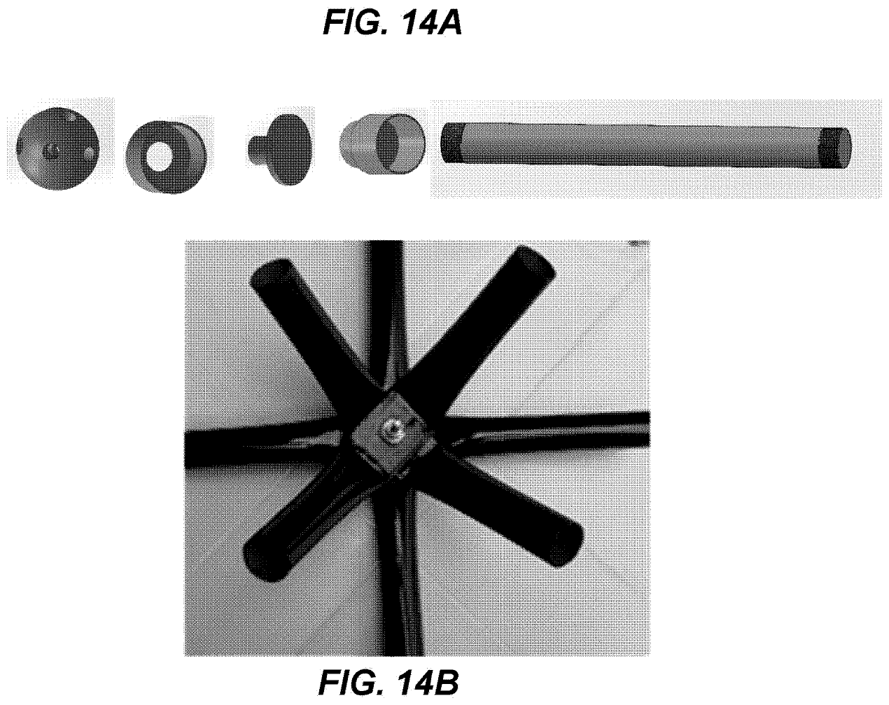

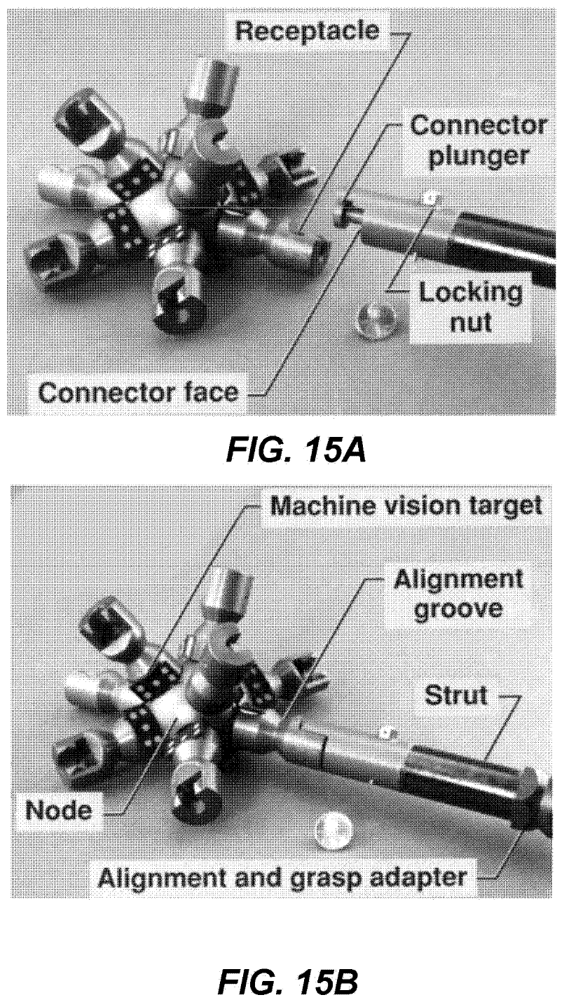

FIG. 14A depicts an example of a truss bar and a truss connection of a truss system, such as the truss system of FIGS. 13A and 13B. In the example of FIG. 14A, a truss bar, a truss node, and connection hardware are illustrated. The truss bar may couple to the truss connection (or truss bar connection) or node via threads. To illustrate, the node or connection point may include multiple threaded holes (e.g., screw holes) to receive an external thread element (e.g., screw) that protrudes from or is coupled to the truss bar. In the example illustrated in FIG. 14A, the truss bar does not include a threaded element that couples directly to the node, but rather includes threads to couple to connection adapters which include an external threaded element that couples to the node.

FIG. 14B depicts a picture of one example design of a truss connection. In the example of FIG. 14B, each truss bar member includes a flat surface on one end, such as a straight or an angled flange, which may be coupled with other truss bars to form a node or connection point. In the example of FIG. 14B, the connection point includes 8 truss members and is formed from joining flanges associated with the 8 truss members. In some implementations, each truss member may be separated and joined via its corresponding flange. In other implementations, multiple truss members may be associated with a joint flange and coupled with one or more other truss members via the joint flange. As illustrative, non-limiting examples, the truss connection may be formed from one straight flange for the planar truss members and one angled flange for the angle truss members, or the truss connection may be formed from four straight flanges for the planar truss members and four angled flanges for the angled truss members.

FIGS. 15A and 15B depict pictures of another example design of a truss connection. FIGS. 15A and 15B each depict a picture of the example truss locking design with FIG. 15A illustrating the truss connection or node separate from an example truss strut and FIG. 15B illustrating the truss connection or node connection to the example truss strut.

Referring to FIG. 15A, FIG. 15A illustrates a connection or coupling between a truss strut receptacle and a truss strut. The truss strut includes a connector side with a connector plunger mounted on or extending from a connector face. The truss strut also includes a locking nut.

Referring to FIG. 15B, FIG. 15B illustrates the connection or coupling between a truss strut receptacle and a truss strut of FIG. 15A where the truss strut is coupled to the truss strut receptacle. The truss strut receptacle defines a receptacle or opening accessible via a keyway or path referred to as an alignment grove. The connector plunger of the truss strut is aligned with the alignment grove and inserted into the receptacle of the truss strut receptacle to couple the two elements. The two elements may be locked with a locking nut to secure the two elements for operations. The strut may move and twist within the receptacle and the connector plunger may also move to enable lateral or axial movement along a longitudinal axis of the strut.

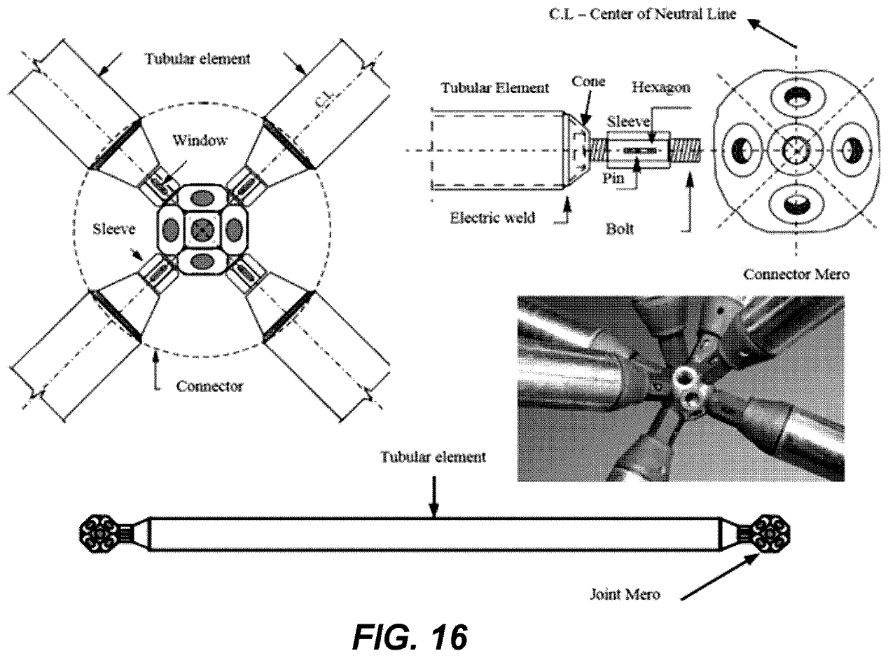

FIG. 16 depicts an image of another example design of a truss connection and corresponding diagrams. In FIG. 16, an image of another example design of a truss connection formed with a connector with a plurality of threaded recesses or holes and a plurality of truss members each with a threaded bolt extending from at least one end. The connector includes a plurality of angle faces, each having a threaded recess for receiving a threaded bolt of a truss member. The connector may enable multiple truss members to be attached via the threaded bolts. As illustrated in the image, seven truss members are connected and the connector still has many open threaded recesses for attachment of additional truss members.

In some implementations, the connection may include additional connection hardware, such as a connection sleeve. The connection sleeve may be threaded onto the bolt and include a pin. The pin may be configured to engage with the threads of the bolt and to secure the sleeve to the bolt. The sleeve may be used as a spacer to ensure proper connection depth, and/or be used to lock the bolt to the connectors, that is to lock the bolt into the threaded recess.

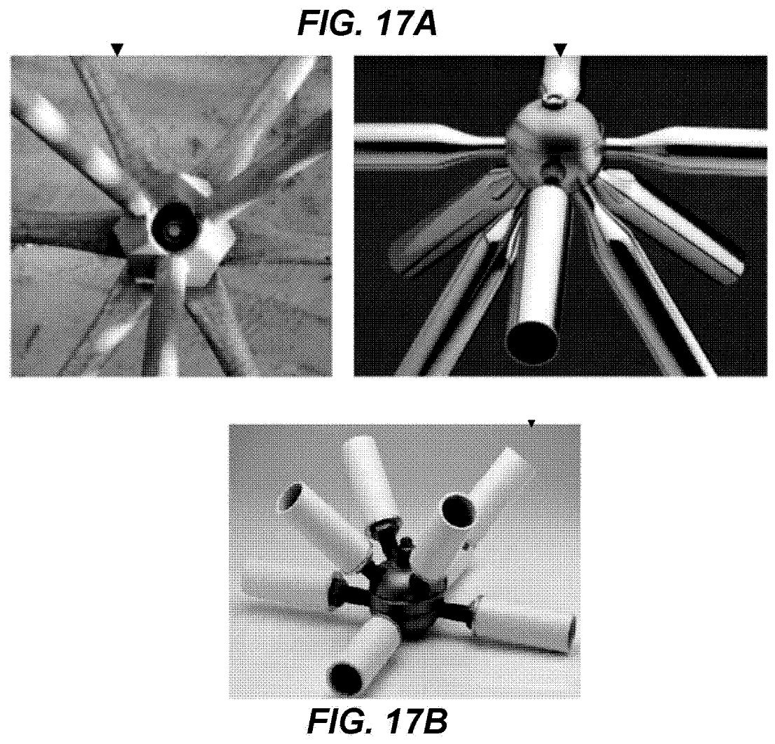

FIGS. 17A-17C depicts pictures of other example designs of a truss connection. FIGS. 17A and 17B each depict a picture of one example truss locking design. FIG. 17A illustrates one example of a fixed truss system and FIG. 17B illustrates one example of an octet truss system. FIG. 17C illustrates an example of a ball joint truss connection that enables truss member movement and flexibility.

Referring to FIG. 17A, the left picture of FIG. 17A illustrates a fixed connection or node of a truss structure. In the fixed connection example of FIG. 17A, the node has nine connections for nine truss members. The node enables six connections in a single plane (e.g., horizontal plane), and three angled connections in a vertical plane. In FIG. 17A, the six planar or in-plane connections are formed by coupling one or more flanges associated with the six planar truss members to a single flange coupled to the three angled connections by a fastener, such as a bolt or threaded screw.

The right picture of FIG. 17A illustrates a fixed or semi-fixed connection or node of a truss structure. In the fixed or semi-fixed connection example of FIG. 17A, the node has eight connections for eight truss members. The node enables four connections in a single plane (e.g., horizontal plane), and four angled connections in a vertical plane. In FIG. 17, the four planar or in-plane connections are formed by coupling one or more ends associated with each of the four planar truss members to connection points extending from a spherical node and by coupling one or more ends associated with each of the four angled truss members to connection points extending from the spherical node. The spherical node may include or be formed from a plurality of elements that are fastened or coupled together. For example, the spherical node may include a top, middle, and/or bottom portion. The different connection points may be positioned on or more of the portion or separate elements of the spherical node. Having connection points on different elements of the spherical node may enable some movement between truss members of different nodes. For example, the planar truss members may be able to be rotated with respect to the angled truss members. To illustrate, the planar truss member may be mounted on the middle portion or ring which may rotate relative to the top and/or bottom portions.

Referring to FIG. 17B, FIG. 17B illustrates a ball joint style truss connection for spatial lattice truss structures. In the example of FIG. 17B, steel rods include screwed ball head terminals. The joint includes three circular elements, two caps, and a central plate that encloses them. Each of the circular elements is joined together by one or more fasteners, such as a single screw. The two caps may be symmetrical and are equipped with slots and housings in which the terminals of the rods are coupled. The spherical head terminals are fixed by a locknut and screwed directly onto the tapered rods. After locking, all converging rods in the node have the ability to rotate in space.

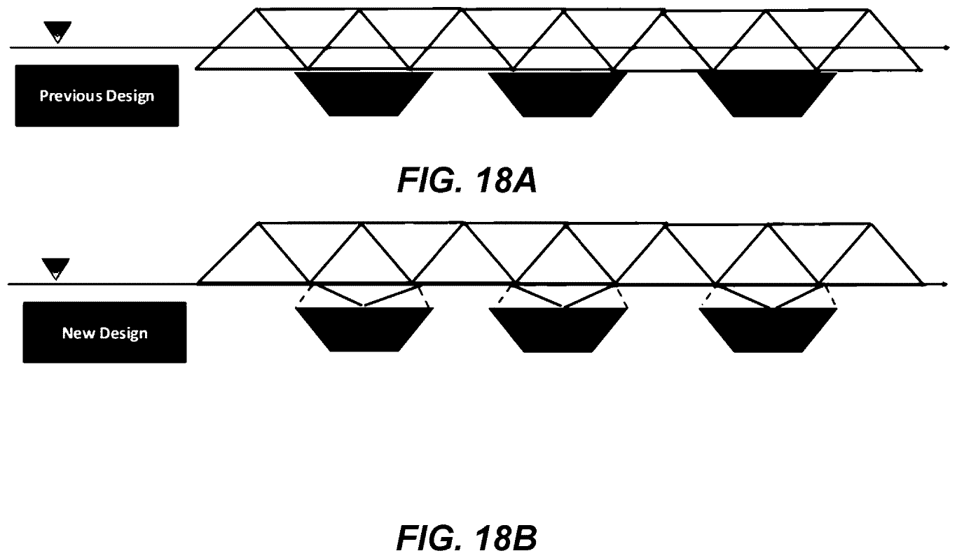

FIGS. 18A and 18B each illustrate an example of truss-to-pod connection designs. FIG. 18A illustrates a truss-to-pod connection using a planar bottom truss element and enabling one or multiple connection points along the bottom truss element. FIG. 18B illustrates a truss-to-pod connection using additional truss connection elements extending from the bottom planar truss element (e.g., blue truss member of FIG. 2E) and enabling one or multiple connection points along or in between the bottom planar truss element. The example of FIG. 18 may enable angled connections between the truss structure and pods.

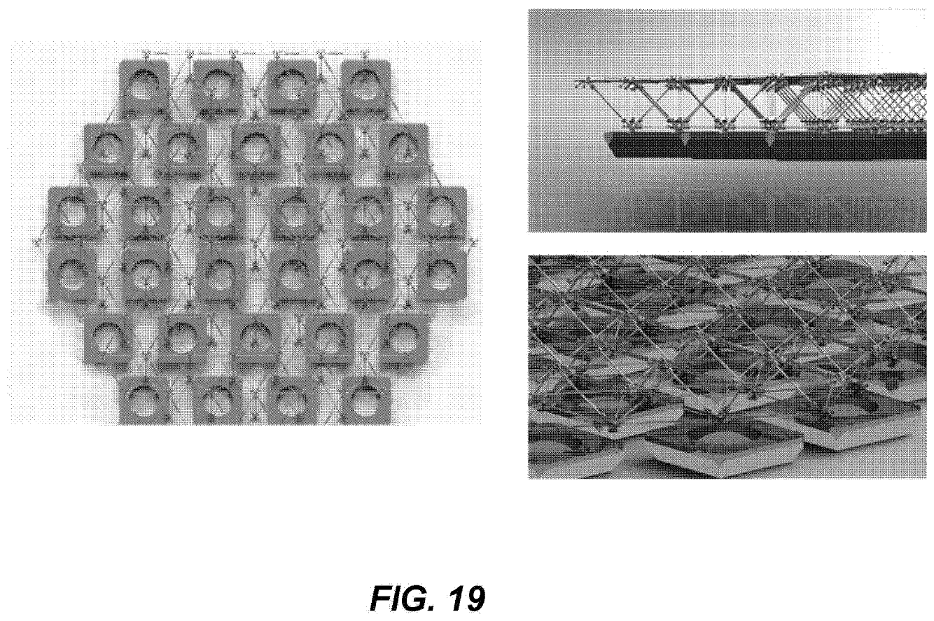

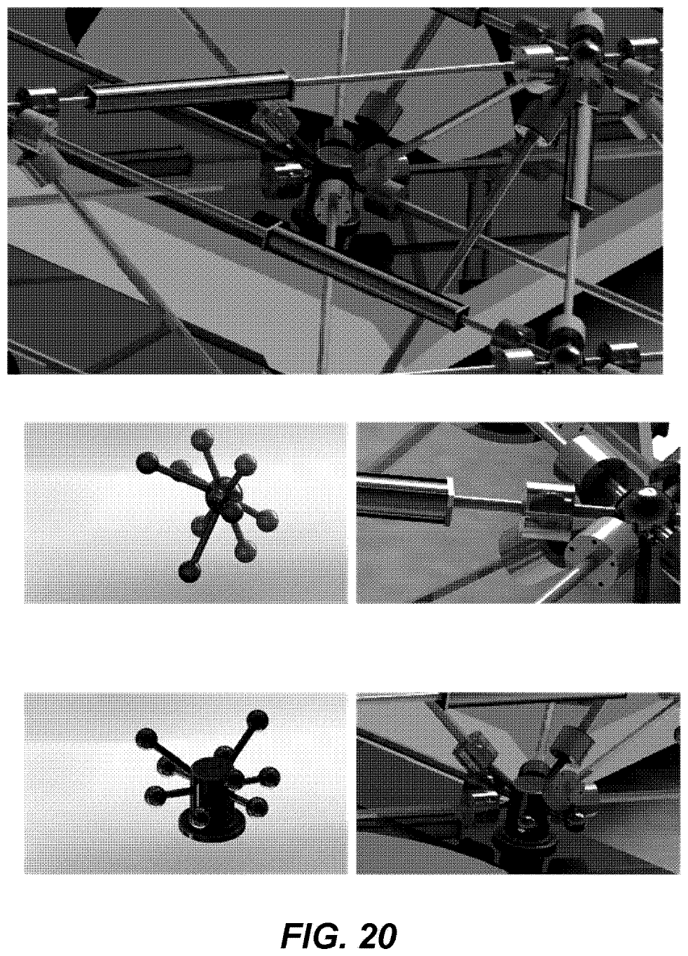

FIG. 19 illustrates a series of renderings of a truss structure. In FIG. 19, top, side, and isometric view rendered images are illustrated. The top view rendered image is shown on the left. The side view rendered image is shown on the top right, and the isometric view rendered image is shown on the bottom right. As illustrated better in the side and isometric views the structure is made up of a plurality of angled truss members forming a plurality of triangles. Example truss connections of the truss structure of FIG. 19 are illustrated and described further with reference to FIG. 20.

FIG. 20 illustrates a series of renderings of a truss connection, such as the truss connections illustrated in the truss structure of FIG. 19. In the first rendered image of FIG. 20, a full truss-to-pod connection is illustrated, and a truss connection is also illustrated. The green objects on the top truss members may include or correspond to adjustable truss members and/or generators. A more detailed explanation of the truss-to-pod connection is described with reference to the fourth and fifth rendered images and a more detailed explanation of the truss connection is described with reference to the second and third rendered images.

In a second rendered image of FIG. 20, a simplified view of the truss connection of the first rendering is illustrated. As illustrated, the truss connection includes a plurality of ball joint connections, nine in the example of FIG. 20. Each ball joint connection includes a truss member (e.g., rod) extending from a central spherical hub and ending in a smaller spherical element (i.e., the ball of the ball joint). The ball may enable the truss to have rotation and translation movement.

In a third rendered image of FIG. 20, a close-up of the truss connection is illustrated and depicts a ball joint connection. As illustrated in the third rendered image, a top truss bar and/or generator may include a hollow cylindrical receptacle coupled to the spherical element of the truss connection or node. The cylindrical receptacle and spherical element enable the truss to move laterally and/or rotate.

In a fourth rendered image of FIG. 20, a simplified view of the truss-to-pod connection of the first rendering is illustrated. As illustrated, the truss-to-pod connection includes a plurality of ball joint connections, nine in the example of FIG. 20. Each ball joint connection includes a truss member (e.g., rod) extending from a central spherical hub and ending in a smaller spherical element (i.e., the ball of the ball joint). The ball may enable the truss to have rotation and translation movement.

In a fifth rendered image of FIG. 20, a close-up of the full truss-to-pod connection is illustrated and depicts a ball joint connection. As illustrated in the third rendered image, a bottom truss bar may include a hollow cylindrical receptacle coupled to the spherical element of the truss connection or node. The cylindrical receptacle and spherical element enable the truss to move laterally and/or rotate.

FIGS. 21A-21H illustrates examples of different pod layouts and corresponding truss structure layouts. In the examples of FIGS. 21A-21H, different-shaped individual pod designs are illustrated, and different-shaped pod configurations are illustrated. In top views. In FIGS. 21A-21H, red lines depict truss bars (truss web bars, top truss bars, and bottom truss bars, etc.), green represents pods, and black dots or circles depict pod array vertices, such as pod-to-truss connections. In FIGS. 21A, 21B, and 21H, the GPE system is depicted at a 1/50 scale, while FIGS. 21D, 21E, 21F, and 21G depict the GPE system at a 1/(2.5) scale. FIG. 21C depicts the GPE in a full-scale representation. Additionally, the GPE system can be scaled to specific deployment conditions to have maximum resonance, thus allowing for the optimization of power capture.

Referring to FIG. 21A, a hexagonal overall pod layout design is illustrated which includes square-shaped pods with small circular cutouts. In FIG. 21A, the pod length is approximately 0.5 meters, the pod breadth is approximately 0.5 meters, and the pod height is approximately 0.1 meters. The pod-to-pod spacing is approximately 0.2 meters. The entire length of the pod array is approximately 4 meters, and the entire breadth of the pod array is 3 meters. The height of the pod array is similar to the pod height, approximately 0.1 meters, and the submergence depth is approximately 0.1-0.01 meters.

In FIG. 21A, the top and bottom truss bars have a length of approximately 0.4 meters, the truss web bars have a length of approximately 0.25 meters, and the truss structure height is approximately 0.1 meters. The cross-section area is approximately 1.6e−4 meters squared. The maximum CWR of the example of FIG. 21A is approximately 0.73 for waves with a 1.41 second peak period and for waves incoming at 0 degrees.

Referring to FIG. 21B, another hexagonal overall pod layout design is illustrated which includes square-shaped pods with circular cutouts. In FIG. 21B, the pod length is approximately 0.5 meters, the pod breadth is approximately 0.5 meters, and the pod height is approximately 0.1 meters. The pod-to-pod spacing is approximately 0.2 meters. The entire length of the pod array is approximately 4 meters, and the entire breadth of the pod array is 3 meters. The height of the pod array is similar to the pod height, approximately 0.1 meters, and the submergence depth is approximately 0.1-0.01 meters.

In FIG. 21B, the top and bottom truss bars have a length of approximately 1 meter, the truss web bars have a length of approximately 0.5 meters, and the truss structure height is approximately 0.2 meters. The cross-section area is approximately 9.5e−5 meters squared. The maximum CWR of the example of FIG. 21B is approximately 0.62 for waves with a 1.27 second peak period and for waves incoming at 0 degrees.

Referring to FIG. 21C, another hexagonal overall pod layout design is illustrated which includes square-shaped pods without cutouts. In FIG. 21C, the pod length is approximately 26 meters, the pod breadth is approximately 23 meters, and the pod height is approximately 5 meters. The pod-to-pod spacing is approximately 7-8 meters. The entire length of the pod array is approximately 200 meters, and the entire breadth of the pod array is 170 meters. The height of the pod array is similar to the pod height, approximately 5 meters, and the submergence depth is approximately 1 meter.

In FIG. 21C, the top and bottom truss bars have a length of approximately 20 meters, the truss web bars have a length of approximately 12 meters, and the truss structure height is approximately 9 meters. The cross-section area is approximately 6.0e−1 meters squared. The maximum CWR of the example of FIG. 21C is approximately 0.64 for waves with a 7 second peak period and for waves incoming at 90 degrees.

Referring to FIG. 21D, a rectangular overall pod layout design is illustrated which includes square-shaped pods with large circular cutouts. In the example of FIG. 21D, the overall rectangular truss structure layout is comprised of smaller triangular truss structures. Such a truss structure may enable the pods to be separated into groups that move independently of one another. Furthermore, due to the slenderness of the overall pod layout and system arrangement, this design is most efficient in the one directional wave sea states and maximum energy is captured by aligning this GPE system along the wave direction.

In FIG. 21D, the pod length and breadth are approximately 9 meters, and the pod height is approximately 2 meters. The pod-to-pod spacing is approximately 3 meters. The entire length of the pod array is approximately 120 meters, and the entire breadth of the pod array is approximately 30 meters. The height of the pod array is similar to the pod height, approximately 2 meters, and the submergence depth is approximately 1 meter.

In FIG. 21D, the top and bottom truss bars have a length of approximately 9 meters, and the truss structure height is approximately 0.5 meters. The cross-section area is approximately 1.1e−2 meters squared. The maximum CWR of the example of FIG. 21D is approximately 0.49 for waves with a 6 second peak period and for waves incoming at 0 degrees.

Referring to FIG. 21E, a triangular overall pod layout design is illustrated which includes square-shaped pods with large circular cutouts. In the example of FIG. 21E, the overall triangular truss structure layout includes a layout similar to the hexagonal and rectangular truss structure described with reference to FIGS. 21A-21D. Such a truss structure may enable the pods to be separated from one another and/or into groups that form smaller portions of the overall triangle and move independently of one another.

In FIG. 21E, the pod length and breadth are approximately 9 meters, and the pod height is approximately 2 meters. The pod-to-pod spacing is approximately 3 meters. The entire length of the pod array is approximately 80 meters, and the entire breadth of the pod array is 70 meters. The height of the pod array is similar to the pod height, approximately 2 meters, and the submergence depth is approximately 1 meter.

In FIG. 21E, the top and bottom truss bars have a length of approximately 6 meters, and the truss structure height is approximately 1 meter. The cross-section area is approximately 1.0e−2 meters squared. The maximum CWR of the example of FIG. 21E is approximately 0.32 for waves with a 7 second peak period and for waves incoming at 90 degrees.

Referring to FIG. 21F, another triangular overall pod layout design is illustrated which includes square-shaped pods with large circular cutouts. In the example of FIG. 21F, the overall triangular truss structure layout is comprised of smaller triangular truss structures and triangular-shaped open spaces. The truss structure includes similar triangular and hexagonal-shaped individual truss elements for a portion of the pods like the examples of FIGS. 21A-21E. However, the truss structure also omits certain trusses from triangularly shaped sections such that particular pods may be connected to trusses at more connection points than other pods. Such a truss structure may enable the pods to be separate groups that form smaller triangles and move independently of one another.

In FIG. 21F, the pod length and breadth are approximately 9 meters, and the pod height is approximately 2 meters. The pod-to-pod spacing is approximately 3 meters. The entire length of the pod array is approximately 80 meters, and the entire breadth of the pod array is 70 meters. The height of the pod array is similar to the pod height, approximately 2 meters, and the submergence depth is approximately 1 meter.

In FIG. 21F, the top and bottom truss bars have a length of approximately 6 meters, and the truss structure height is approximately 1 meter. The cross-section area is approximately 7.0e−3 meters squared. The maximum CWR of the example of FIG. 21F is approximately 0.32 for waves with a 7.0 second peak period and for waves incoming at 90 degrees.

Referring to FIG. 21G, a square overall pod layout design is illustrated which includes square-shaped pods with large circular cutouts. In the example of FIG. 21G, the overall square truss structure layout includes a layout similar to the triangular, rectangular, and hexagonal truss structure described with reference to FIGS. 21A-21F. Such a truss structure may enable the pods to be separated from one another and/or into groups that form smaller portions of the overall triangle and move independently of one another.

In FIG. 21G, the pod length and breadth are approximately 9 meters, and the pod height is approximately 2 meters. The pod-to-pod spacing is approximately 3 meters. The entire length of the pod array is approximately 70 meters, and the entire breadth of the pod array is 57.70 meters. The height of the pod array is similar to the pod height, approximately 2 meters, and the submergence depth is approximately 1 meter.

In FIG. 21G, the top and bottom truss bars have a length of approximately 9 meters, and the truss structure height is approximately 1 meter. The cross-section area is approximately 3.2e−2 meters squared. The maximum CWR of the example of FIG. 21G is approximately 0.42 for waves with a 6.5 second peak period and for waves incoming at 0 degrees.

Referring to FIG. 21H, a hexagonal overall pod layout design is illustrated which includes square-shaped pods with circular cutouts. In the example of FIG. 21H, the overall hexagonal truss structure layout includes a layout similar to the hexagonal truss structures described herein and includes truss connector web bars similar to FIG. 18B. Such a truss structure and pod-to-truss connection system may enable the pods to be separated from one another and/or into groups that form smaller portions of the overall triangle and move independently of one another. Similar to previous representations, the blue lines are bottom truss bars, the red lines are top truss bars, and the green lines are truss web bars. The black lines are truss connector web bars to connect the bottom truss bars to the pods. In the example of FIG. 21H, the truss connector web bars connect to vertices or interconnect between bottom truss bars in a triangular fashion to the pods.

In FIG. 21H, the pod length is approximately 0.5 meters, the pod breadth is approximately 0.4 meters, and the pod height is approximately 0.1 meters. The pod-to-pod spacing is approximately 0.15 meters. The height of the pod array is similar to the pod height, approximately 0.15 meters, and the submergence depth varies by pod group. The submergence depth may include approximately −0.020 meters for the first group, approximately −0.025 meters for the second group, and approximately −0.015 meters for the third group.

In FIG. 21H, the top and bottom truss bars have a length of approximately 0.4 meters, and the truss structure height is approximately 0.2 meters. The cross-section area is approximately 1.82e−5 meters squared. The maximum CWR of the example of FIG. 21H is approximately 0.861 for waves with a 1.5 second peak period and for waves incoming at 0 degrees.

Although the example configurations of FIGS. 21A-21G illustrate particular combinations of truss structures, pod layouts, pod designs and element dimensions, such are illustrative, non-limiting examples. In other implementations, other shapes and configurations may be used and different combinations of configurations may be combined. As illustrative examples, of truss structures, the truss structure may have differently shaped truss elements, such as rectangular, square, octagonal, etc. Additionally, or alternatively, the individual pod design may have a different shape (e.g., 2D face shape or cross-section parallel to the water), such as elliptical, rectangular, triangular, pentagonal, hexagonal, octagonal, etc. In addition, although some of the pods have circular cutouts and corner chamfers, in some implementations, the cutouts may be a different shape, such as elliptical, rectangular, triangular, pentagonal, hexagonal, octagonal, circular, etc., and/or corners may be rounded or have hard edges. In some particular implementations, only one side of the pod may have a corner feature. To illustrate, only a bottom side, top side, or ocean-facing side may have a chamber or rounding. Similarly, the overall pod layout may have a different shape, circular, pentagonal, octagonal, etc. Moreover, in other implementations different sized or dimension components may be used to adjust a size of the system and/or different amounts of components (e.g., pods, trusses, etc.) may be used to increases or decrease an overall size of the system.

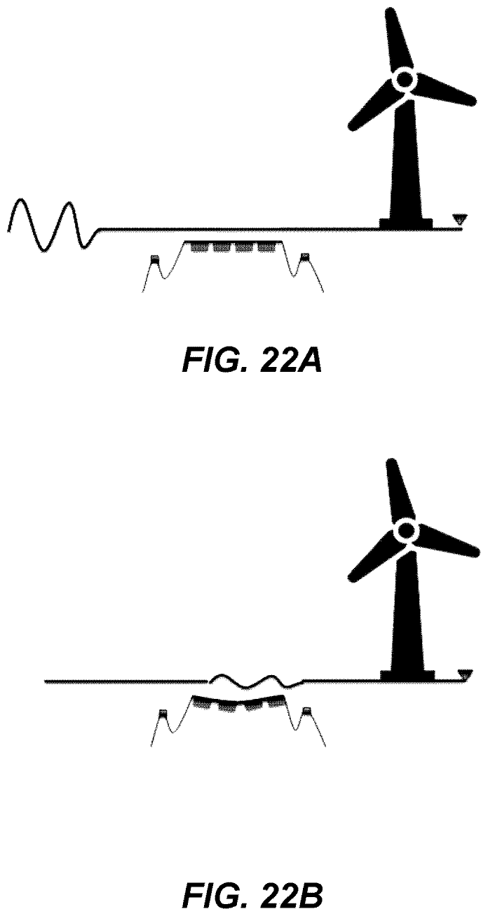

FIGS. 22A and 22B illustrate an example of an energy generation system positioned near shoreline or water-based infrastructure. FIGS. 22A and 22B depict an example operation of a system generating energy from waves near shorelines or water-based infrastructure.

When positioned near a shoreline and/or water-based infrastructure, the system absorbs or extracts a portion of the kinetic and potential energy of the waves and helps protect or insulate the shoreline and/or water-based infrastructure from the full kinetic and potential energy of the waves and thus reduces wear and erosion on the kinetic and potential energy of the waves.

During operation, waves may propagate through the ocean and reach the system. The system may move with the waves and generators thereof may extract energy from the waves and generate electricity from the waves. The waves may have a reduced energy after passing through the system and may interact with (e.g., hit or impact) the shoreline or water-based infrastructure with less energy. Accordingly, the system may not only generate energy from the waves but may also protect shoreline or water-based infrastructure from erosion.

Additionally, in some implementations, the system may be configured to reduce local energy absorption of the water where it is placed. For example, the system may be made of material or have a coating that reflects light (e.g., solar energy, UV radiation, etc.) and reduces the amount of energy transferred to the water as compared to the area without the system (e.g., water alone). Accordingly, the system may reduce local solar energy absorption and may reduce water temperatures, or at least not contribute to increased water temperatures.

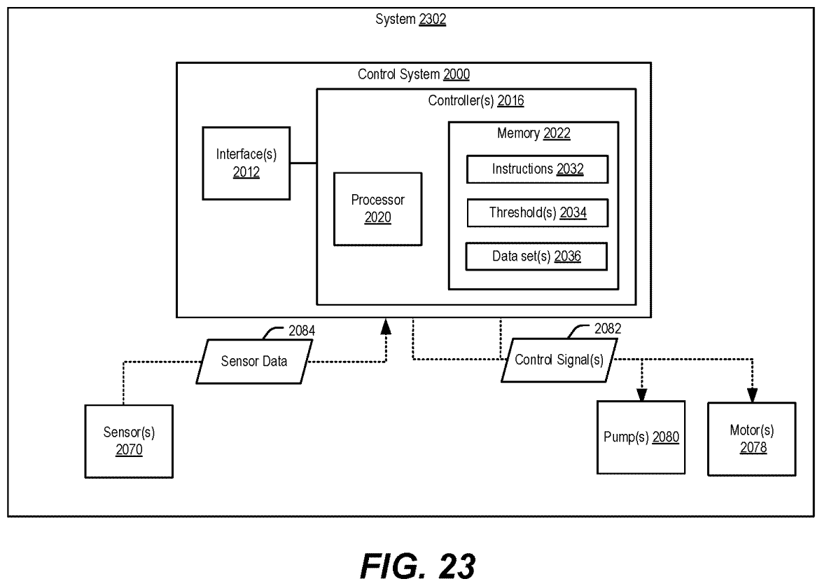

Referring to FIG. 23, a block diagram of an example of a control system 2302 of a system 2300 is shown. Control system 2302 may include or correspond to an electronic device or system. Control system 2302 may be configured to operate system 2300 by varying the power-take-off damping, stiffness and the submergence depth using buoyancy control, such that system 2300 extracts energy from ocean waves and may be adjusted to increase energy extraction from ocean waves in different operating conditions, such as from waves with different directions, magnitudes, frequencies, etc.

As shown in FIG. 23, the control system 2302 includes one or more interfaces 2312 and one or more controllers, such as a representative controller 2316. Interfaces 2312 may include a network interface and/or a device interface configured to be communicatively coupled to one or more other devices, such as sensors 2370, pumps 2380, and/or motors 2378. For example, interfaces 2312 may include a transmitter, a receiver, or a combination thereof (e.g., a transceiver), and may enable wired communication, wireless communication, or a combination thereof.

One or more controllers (e.g., controller 2316) include one or more processors and one or more memories, such as representative processor 2320 and memory 2322. Memory 2322 may include executable instructions 2332. The one or more sets of instructions 2332 may be further based on thresholds 2334, the dataset(s) 2336 stored in memory 2322 that aid in determining control signals 2382 (e.g., one or more output settings), and/or one or more translation algorithms for generating control signals 2382. For example, instructions 2332 may be based on thresholds 2334 and/or data set(s) 2336 stored in memory 2322 that aid in determining the one or more control signals 2382 (e.g., dimensions, measurements, and/or other parameters of pump 2380 and/or motor 2378 operation). To illustrate, the instructions 2332 may execute when thresholds 2334 for sensor data 2384 stored in memory 2322 are reached.

As shown in FIG. 23, processor 2320 is coupled to the memory 2322 and configured to execute the one or more instructions. Processor 2320 may include or correspond to a microcontroller/microprocessor, a central processing unit (CPU), a field-programmable gate array (FPGA) device, an application-specific integrated circuits (ASIC), another hardware device, a firmware device, or any combination thereof. Processor 2320 may be configured to execute instructions to initiate or perform one or more operations described with reference to FIG. 1-22 or 24-26.

In some implementations, control system 2302 may be configured to receive sensor data 2384 and generate and/or communicate control signals 2382 (e.g., one or more output settings) for pumps 2380 and/or motors 2378, based on the sensor data 2384. The one or more sets of instructions 2332 may be further based on thresholds 2334 and/or data set(s) 2336 stored in memory 2322 that aid in determining the one or more output settings indicated by control signals 2382.

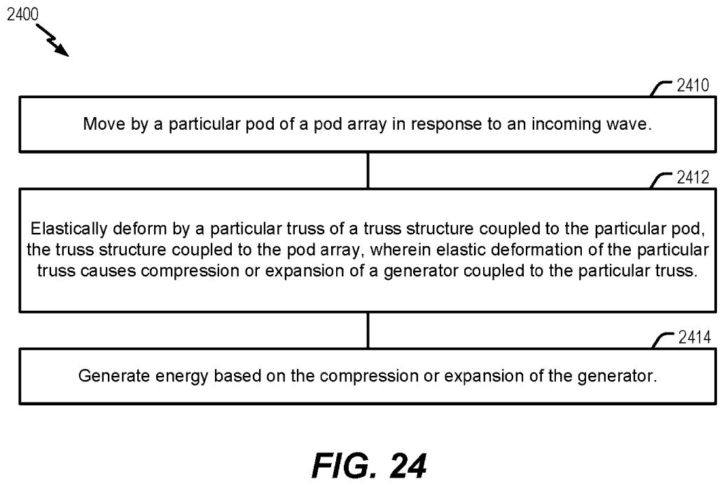

Referring to FIG. 24, FIG. 24 illustrates a flowchart of example energy generation operations by the aspects described herein. For example, the operations in FIG. 24 may be performed by one or more of the energy generation systems described herein.

The method includes, at 2410, moving by a particular pod of a pod array in response to an incoming wave. For example, one or more pods of the array may change an overall height or position responsive to a passing wave by rising or failing with the wave and/or changing a submergence depth with the passing wave. To illustrate, a pod may increase height and then decrease height as a wave crest passes through the pod while keeping a submergence depth in the water similar.

The method also includes, at 2412, elastically deforming by a particular truss of a truss structure coupled to the particular pod, the truss structure coupled to the pod array, wherein elastic deformation of the particular truss causes compression or expansion of a generator coupled to the particular truss. The elastic deformation may be responsive to movement by the particular pod from a passing wave. To illustrate, the particular truss is coupled to the particular pod which moves, and the particular truss may apply or transfer forces received by the pod and/or movement thereof to the generator.

The method further includes, at 2414, generating energy based on the compression or expansion of the generator. For example, the compression or expansion of the generator as illustrated in FIGS. 3C and 3D may generate electricity, as described with reference to FIG. 1.

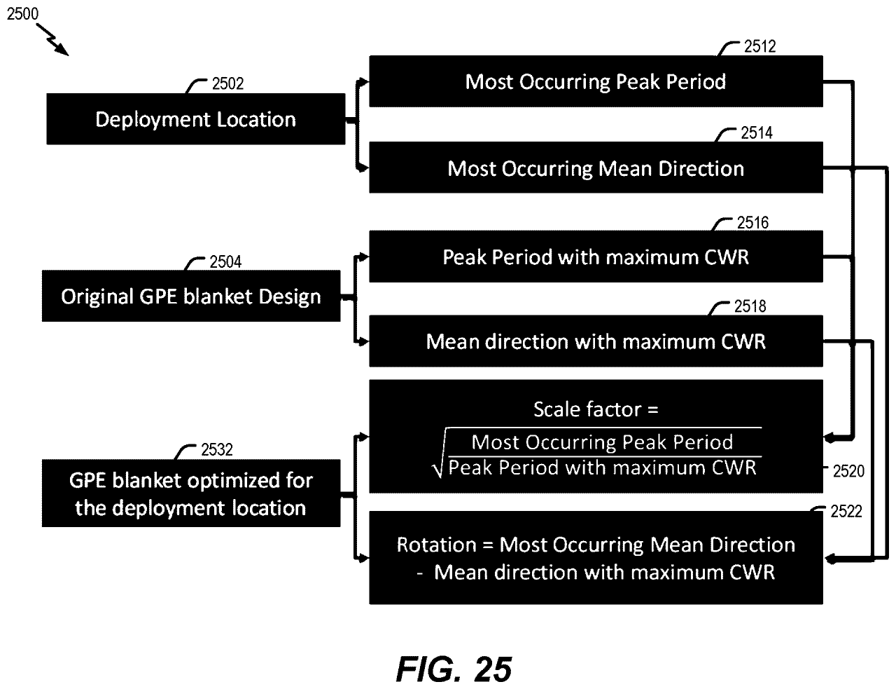

Referring to FIG. 25, FIG. 25 illustrates a flowchart of an example of deployment scaling for the systems described herein. For example, the operations in FIG. 25 may be performed to adjust one or more parameters of one or more of the energy generation systems described herein to fit a particular deployment scenario, such as location (e.g., depth, space, etc.), wave profile (e.g., wave intensity and frequency), etc. For the systems described herein, any combination of parameters may be adjusted to increase efficiency of the energy generation systems. As illustrative, non-limiting examples, pod size, pod shape, pod depth, pod spacing, truss type or shape, truss size, truss member dimensions, truss connection types, linear generator parameters, etc., or any combination thereof may be adjusted to increase system performance, as shown in the examples of FIGS. 21A-21H.

Each potential deployment location for the energy generation systems described herein may have unique characteristics that may reduce or degrade performance of a particular design. Thus, when deploying the energy generation systems described herein at a particular location, the energy generation systems may be adjusted or scaled based on the operations depicted in FIG. 25, and according to the factors specified in the in FIG. 25 to prevent this reduction and/or optimize the energy generation system for the particular location.

In FIG. 25, multiple adjustments are described to adjust or improve a system for a particular deployment location. For example, after identification or selection of a deployment location 2502 and a system design 2504, such as the design of FIG. 21A, the operation includes determining a most occurring wave peak period 2512, such as an average or mean wave peak period, and determining a most occurring wave direction 2514, such as an average or mean wave direction of the waves of the deployment location 2502. The operation also includes determining a maximum CWR wave peak period 2516 for the system design 2504, such as a wave peak period that produces a highest CWR value for the system design 2504, and determining a maximum CWR wave direction 2518 for the system design 2504, such as a wave direction (or mean wave direction) that produces a highest CWR value for the system design 2504. The maximum CWR wave peak period 2516 and the maximum CWR wave direction 2518 for the system design 2504 may be determined through testing and/or computational analysis.

After determination of maximum or optimized values (2512-2518) for the wave peak period and the wave direction for both the deployment location 2502 and the system design 2504, the determined wave peak period and the wave direction values may be used to optimize a particular design, the system design 2504, for a particular location, the deployment location 2502. For example, the operation may include optimizing the design at 2532 by using a scaling factor to adjust a scale of the system design 2504 based on the peak period values 2512 and 2516. To illustrate, the operation may include determining the scale factor based on a square root of the most occurring peak period 2512 divided by the maximum CWR wave peak period 2516. Additionally, the operation may also include optimizing the design at 2532 by rotating the system design 2504 to align the most occurring wave direction 2514 with the maximum CWR wave direction 2518. To illustrate, the operation may include determining a rotation value for the system design 2504 based on a difference of the most occurring wave direction 2514 and the maximum CWR wave direction 2518.

As an illustrative, non limiting example, to optimize a particular system designed for a wave peak period of 1.5 seconds (e.g., the maximum CWR wave peak period 2516) and a 60 degree mean wave direction (e.g., the maximum CWR wave direction 2518) for installation in Galveston Bay, where the most occurring wave peak period is 6.0 seconds (e.g., the most occurring wave peak period 2512) and the waves have a mean direction of 90 degrees (most occurring wave direction 2514), a scaling factor of 2 may be used to scale the system to optimize performance. To illustrate, the scaling factor of 2 is determined by taking the square root of the 6.0 seconds divided by 1.5 seconds (i.e., 4). Additionally, a 30 degree rotation maybe applied to the system to optimize performance in Galveston Bay. To illustrate, the 30 degree rotation is determined by a difference of 90 degrees minus 60 degrees (i.e., 30 degrees). Accordingly, the operations in FIG. 25 may enable a size of a system to be reduced or enlarged and rotated to fit a target area and to reach a desired amount of power generated, while optimizing its operation for a particular deployment location.

While FIG. 25 illustrates an example of modifying a selected system to fit a particular deployment location, the process may be iteratively performed to identify which system of a plurality of systems may have the best overall performance. For example, two systems may be evaluated for a single location to identify which system has the highest efficiency or CWR after modification or to identify a system which requires the least amount of modifications or scaling.

In addition, while FIG. 25 illustrate an example of scaling a system to fit a location, a system design may be modified to adjust its maximum CWR wave peak period 2516 and/or its maximum CWR wave direction 2518. For example, the various different designs provided herein have different values for maximum CWR wave peak period 2516 and/or its maximum CWR wave direction 2518 based on adjustments to pod shape, pod size, truss size, materials used, etc., as described with reference to FIGS. 21A-21H. By adjusting such parameters, the maximum CWR wave peak period 2516 and/or maximum CWR wave direction 2518 may be adjusted. As illustrative, and simplified additional examples for adjusting a system design to change a maximum CWR wave peak period 2516 and/or a maximum CWR wave direction 2518, pod dimensions may be reduced for areas with waves that have shorter peak periods and may be increased for areas with waves that have larger peak periods. Additionally, truss dimensions, material strength, and connection stiffness may be reduced for areas with waves that have shorter peak periods and may be increased for areas with waves that have larger peak periods. Pod shape and arrangement may be modified, such as rotated, to account for changes in wave direction. Accordingly, a system design may also be modified to adjust the maximum CWR wave peak period 2516 and/or a maximum CWR wave direction 2518.

Referring to FIG. 26, FIG. 26 illustrates a flowchart of an example of system design and optimization for the systems described herein. For example, the operations in FIG. 26 may be performed to adjust one or more parameters of one or more of the energy generation systems described herein to fit a particular deployment scenario, such as location (e.g., depth, space, etc.), wave profile (e.g., wave intensity and frequency), etc. For the systems described herein, any combination of parameters may be adjusted to increase efficiency of the energy generation systems. As illustrative, non-limiting examples, pod size, pod shape, pod depth, pod spacing, truss type or shape, truss size, truss member dimensions, truss connection types, linear generator parameters, etc., or any combination thereof may be adjusted to increase system performance, as shown in the examples of FIGS. 21A-21H.

In FIG. 26, a flowchart of optimizing capture width ratio is illustrated. In the example of FIG. 26, exemplary inputs are illustrated in a table 2602. The inputs corresponds to parameters of the system. The inputs are provided to first generate geometry or dimensions of the components of the system at 2612. These inputs may include the dimensions of the example systems provided herein, such as pod center, pod geometry, truss bar length, truss height, etc.

Static analysis is performed at 2614 on the components to determine modal parameters and elastic modes. For example, static analysis may use additional parameters of the truss bar, such as Young's modulus, density, cross-section area, dashpot coefficient, etc., to evaluate the modal parameters and elastic modes based on the original geometry design.

Boundary element analysis is performed at 2616 using the modal parameters and elastic modes to determine a RAO. For example, boundary element analysis is performed using submergence depth and wave parameters as additional inputs, and using the determined modal parameters and elastic modes to determine the RAO of the system. The RAO may then be used to perform a performance analysis at 2818 on the system to determine performance for particular sea state parameters (e.g., peak period and mean wave direction). For example, a CWR indicating system performance and efficiency is determined based on the performance analysis at 2818. The process shown in FIG. 26 may be repeated to increase or optimize the CWR for a particular sea state, and/or to adjust a design for different sea states.

Accordingly, the flowchart of FIG. 26 enables optimization of a system by adjusting component dimensions and material properties based on the peak period and mean direction of the sea state to generate a maximum CWR. Increased or maximum CWR may be achieved when higher PTO damping/dashpot coefficients are used for higher peak period and lower PTO damping/dashpot coefficients are used for lower peak period. Additionally, or alternatively, higher PTO stiffness and depth for lower peak period and lower PTO stiffness and depth for higher peak period may result in increased or maximum CWR. Cross-section area may have a nonlinear relationship with CWR, where CWR first increases up to a first value (e.g., 0.1 square meter) and then decreases thereafter.

Although the present invention and its advantages have been described in detail, it should be understood that various changes, substitutions, and alterations can be made herein without departing from the spirit and scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, the scope of the present application is not intended to be limited to the particular embodiments of the process, machine, manufacture, composition of matter, means, methods, and steps described in the specification.

What is claimed is:

1. An energy generation system comprising:
a pod array including a plurality of pods; and
a truss structure coupled to the pod array, the truss structure including one or more trusses, wherein at least one truss of the one or more trusses includes a generator configured to generate energy, wherein:
the pods include buoyant material and are configured to float and suspend the truss structure in water and move with incoming waves,
the pods are flexibly coupled to one another and configured to move relative to one another from incoming waves, and
movement of the pods causes movement of the at least one truss of the one or more trusses and the generator thereof and generation of electricity.

2. The energy generation system of claim 1, further comprising:
a pod and truss interconnection system configured to couple the one or more trusses of the truss structure to one or more pods of the pod array, wherein the pod and truss interconnection system includes one or more flexible connections.

3. The energy generation system of claim 1, further comprising:
a mooring system including one or more mooring lines, one or more floats, and one or more weights or anchors and coupled to the pod array, the truss structure or both, the mooring system configured to secure the energy generation system within an operational area with flexible boundary conditions.

4. The energy generation system of claim 1, further comprising:
a depth control system configured to adjust a submergence depth of one or more pods of the pod array.

5. The energy generation system of claim 1, further comprising:
a control system configured to control one or more operating parameters of the energy generation system.

6. The energy generation system of claim 1, further comprising:
a display interface configured to output a GUI for control of the energy generation system; and
a communication interface configured to wirelessly communicate with one or more devices of the energy generation system, one or more external devices, or both.

7. The energy generation system of claim 1, further comprising:
an energy conversion system configured to convert electricity received from the generator to another form of electricity or to adjust a parameter of the received electricity;
an energy transmission system configured to transmit the received electricity or stored electricity; and
an energy storage system configured to store energy based on the electricity generated from the generator.

8. The energy generation system of claim 1, wherein the one or more trusses comprise a plurality of trusses and the plurality of trusses are arranged in a series of repeating geometric shapes, wherein the plurality of trusses has multiple sets of trusses where each set of trusses forms one instance of a geometric shape of the repeating geometric shapes, and wherein at least one truss of each of the multiple sets of trusses includes or is associated with a generator.

9. The energy generation system of claim 8, wherein the geometric shape includes a triangle, a rectangle, a square, a pentagon, a hexagon, or an octagon.

10. A method of energy generation for multi-directional waves, the method comprising:
moving by a particular pod of a pod array in response to an incoming wave;
responsive to movement by the particular pod, elastically deforming by a particular truss of a truss structure coupled to the particular pod, the truss structure coupled to the pod array, wherein elastic deformation of the particular truss causes compression or expansion of a generator coupled to the particular truss; and
generating energy based on the compression or expansion of the generator.

11. The method of claim 10, further comprising:
moving by the particular pod of the pod array in response to a second incoming wave, the second incoming wave having a second direction different from a first direction of the incoming wave;
responsive to movement by the particular pod, elastically deforming by the particular truss of the truss structure a second time, wherein the second elastic deformation of the particular truss causes second compression or expansion of the generator coupled to the particular truss; and
generating second energy based on the second compression or expansion of the generator.

12. The method of claim 10, further comprising:
adjusting, by a control system, a submergence depth of one or more pods of the pod array.

13. The method of claim 10, further comprising:
adjusting, by a control system, one or more parameters of the generator, the one or more parameters includes a stiffness parameter, a damping parameter, or both.

14. The method of claim 10, further comprising:
obtaining, by a control system, wave profile data; and
determining, by the control system, to adjust a submergence depth or generator parameters based on the wave profile data.

15. A system comprising:
the energy generation system of claim 1;
a second energy generation system comprising a second pod array including a second plurality of pods and comprising a second truss structure coupled to the second pod array, the second truss structure including a plurality of second trusses, wherein at least one truss of the plurality of second trusses is coupled to a second generator configured to generate second energy; and
a control system coupled to the energy generation system and the second energy generation system and configured to control energy generation operations of the energy generation system and the second energy generation system.

16. The system of claim 15, further comprising:
a pod and truss interconnection system configured to couple the one or more trusses of the truss structure to one or more pods of the pod array, wherein the pod and truss interconnection system includes one or more flexible connections.

17. The system of claim 15, further comprising:
a mooring system including one or more mooring lines, one or more floats, and one or more weights or anchors and coupled to the energy generation system and the second energy generation system, the mooring system configured to secure the energy generation system and the second energy generation system within an operational area with flexible boundary conditions.

18. The system of claim 15, further comprising:
a depth control system configured to adjust a submergence depth of one or more pods of the pod array and one or more second pods of the second pod array.

19. The system of claim 15, wherein the plurality of second trusses are arranged in a series of repeating geometric shapes, wherein the plurality of second trusses has multiple sets of second trusses where each set of second trusses forms one instance of a geometric shape of the repeating geometric shapes, and wherein at least one truss of each of the multiple sets of second trusses includes or is associated with a generator.

20. The system of claim 19, wherein the geometric shape includes a triangle, a rectangle, a square, a pentagon, a hexagon, or an octagon.
